(19) United States
(12) Patent Application Publication
(10) Pub. No.: US 2026/0120114 A1
(43) Pub. Date: Apr. 30, 2026

(54) PRODUCT RECALL RISK PREDICTION

(71) Applicant: Honeywell International Inc., Charlotte, NC (US)

(72) Inventors: Waad Subber, Schenectady, NY (US); Ankit Singh, Apex, NC (US)

(21) Appl. No.: 18/928,233

(22) Filed: Oct. 28, 2024

(51) Int. Cl. G06Q 30/014; G06F 40/242; G06F 40/279; G06F 40/30; G06F 40/40; G06Q 10/0635

(52) U.S. Cl. CPC G06Q 30/014; G06F 40/242; G06F 40/279; G06F 40/30; G06F 40/40; G06Q 10/0635

(57) ABSTRACT

Example techniques for predicting risk of recall of a product are described. In an example, product recall databases may be accessed to obtain recall data comprising reasons for recall relating to each of a plurality of product categories. A general risk indicator dictionary comprising a grouping of each of general risk indicators with their corresponding list of keywords and a specific risk indicator dictionary comprising a grouping of each of specific risk indicators with their corresponding list of keywords may be created. A general risk indicator is indicative of a user-defined criteria for assessing risk of recall applicable across the plurality of product categories, and a specific risk indicator is indicative of a user-defined criteria for assessing risk of recall of the corresponding product category. The recall data, the general risk indicator dictionary and the specific risk indicator dictionary may be provided to a machine learning (ML) model, to train the ML model for predicting the risk of recall of the product.

### BACKGROUND

A large variety of products, ranging from medical devices to consumable items, are manufactured for various purposes, with each product following a generally predefined manufacturing process. The manufacturing process may be carried out at a facility such as a manufacturing plant and typically includes multiple stages, such as production and testing. Post-manufacturing, activities like packaging and distribution may also be part of the overall process to deliver the product for use. To ensure a predefined quality of the product, each activity during the manufacturing and delivery process may be carried out in accordance with a predefined standard operating procedure (SOP). The SOP may define conditions and constraints for carrying out activities at each stage of the process. Throughout the manufacturing process, the various activities may be monitored and controlled to be in compliance with the respective SOP.

Despite these precautions, there may be instances where the products are discovered to be unsafe after they have been made available in market. Such safety concerns may arise, for instance, from design oversights, production anomalies, or inadvertent use of harmful substances. Additionally, the products that were compliant with regulatory standards when initially made available in the market may become non-compliant due to changes in regulations or newly discovered risks. When faced with these issues, manufacturers of the products may be responsible for taking corrective action, which may include initiating a voluntary recall or complying with a recall mandated by regulatory authorities. In order to recall a product, product recall management systems (PRMS) are used. A PRMS may be understood as a specialized tool that streamlines the process of recalling a product or batches of the product from the market.

Conventional PRMSs are typically used for making decisions about recalls or managing the recall process for products already available in the market. Such systems often implement a reactive approach in addressing potential risks for products yet to be released in the market. This restriction results in addressing problems with the products only after they have manifested, potentially leading to increased risks for consumers and higher costs for the manufacturers.

### SUMMARY

The details of some embodiments of the invention described in this specification are set forth in the accompanying drawings and the description below. Other features, aspects, and advantages of the invention will become apparent from the description, the drawings, and the claims.

The present subject matter relates to methods, systems, and non-transitory computer-readable media for automating risk assessment for product recall prediction based on recall data.

In accordance with an embodiment of present subject matter, a system for predicting risk of recall of a product may include one or more processors and modules coupled to the processors. A data retrieval module coupled to the one or more processors may access at least one product recall database to obtain recall data pertaining to a plurality of categories of products, the recall data comprising one or more reasons for recall relating to each of the product categories. An input module, coupled to the at least one or more processors, may be operable to receive, from a user, general risk indicators corresponding to the plurality of product categories. The general risk indicators are indicative of user-defined criteria for assessing risk of recall of the plurality of product categories. The input module may also receive specific risk indicators corresponding to each product category, the specific risk indicators are indicative of a user-defined criteria for assessing risk of recall of the corresponding product category. A generative module coupled to the at least one or more processors generates a list of keywords for each of the general and specific risk indicators. The keywords comprise one or more terms semantically similar to the corresponding risk indicator. The generative module creates a general risk indicator dictionary comprising a grouping of each of the general risk indicators with their corresponding list of keywords, and a specific risk indicator dictionary comprising a grouping of each of the specific risk indicators with their corresponding list of keywords. A training module coupled to at least one or more processor provides the recall data, general risk indicator dictionary, and specific risk indicator dictionary to a machine learning (ML) model, to train the ML model for predicting the risk of recall of a product.

In accordance with another aspect of the present subject matter, the method to predict risk of recall of a product is described. In an example, a method comprises accessing one or more product recall databases to obtain recall data pertaining to a plurality of categories of products. The recall data comprises one or more reasons for recall relating to each of the plurality of product categories. Upon obtaining the recall data, the method further comprises obtaining a general risk indicator dictionary comprising a set of general risk indicators corresponding to the plurality of product categories. The general risk indicator is indicative of a user-defined criteria for assessing risk of recall of the plurality of product categories. Further, the method comprises obtaining a specific risk indicator dictionary comprising a set of specific risk indicators corresponding to each product category from amongst the plurality of product categories. The specific risk indicator is indicative of a user-defined criteria for assessing risk of recall of the corresponding product category. The general risk indicator dictionary and specific risk indicator dictionary includes a list of keywords for each of the general risk indicators and specific risk indicators, respectively. A keyword is a term semantically similar to the corresponding risk indicator. The method further comprises training a ML model, based on the recall data, for predicting risk of recall of a product. The training comprises assigning, based on the general risk indicator dictionary and the specific risk indicator dictionary, a risk score for each of the general risk indicators and the specific risk indicators. In an example, the risk score may be based on a degree of similarity between the corresponding risk indicator and the one or more reasons for recall of each of the plurality of product categories. On providing a description of the product to the ML model, the method comprises receiving a risk score from the ML model. The risk score is indicative of a possibility of the product being recalled.

In accordance with an embodiment of the present subject matter, the non-transitory computer-readable medium contains instructions that enable a processing resource to access recall data pertaining to a plurality of categories of products from at least one product recall database. In an example, the recall data includes one or more reasons for recall of each of the plurality of product categories. The processing resource is to further receive user input defining general risk indicators corresponding to the plurality of product categories. In an example, a general risk indicator is indicative of a user-defined criteria for assessing risk of recall applicable across the plurality of product categories. In a similar manner, the processing resource is to receive user input defining specific risk indicators corresponding to each product category from amongst the plurality of product categories. In an example, a specific risk indicator is indicative of a user-defined criteria for assessing risk of recall of the corresponding product category. The processing resource is to generate lists of semantically similar keywords for each of the general risk indicators and specific risk indicators and create a general risk indicator dictionary and a specific risk indicator dictionary by grouping each of the general risk indicators with their corresponding list of keywords and each of the specific risk indicators with their corresponding list of keywords, respectively. The processing resource is to further provide, to a machine learning (ML) model, the general risk indicator dictionary and the specific risk indicator dictionary along with the recall data as training data to train the ML model to predict risk of recall of a product. In an example, the ML model may determine, based on the general risk indicator dictionary and specific risk indicator dictionary, a degree of similarity between respective indicators and the reasons for recall of each of the plurality of product categories. The processing resource is to obtain attributes of a new product and provide the same to the trained ML model. In response, the ML model generates a risk score for the new product based on the attributes, the risk score indicating a possibility of the new product being recalled.

Embodiments of the present subject matter provide automated techniques for predicting recall risks of new products, even when specific recall information for these products is not available. This predictive capability allows manufacturers to anticipate potential issues before a new product is launched into a market or just has been launched into the market, enabling proactive problem-solving and saving substantial time and resources typically associated with product recalls. The present subject matter provides a machine learning (ML) model that is trained on historical recall data from similar products categories, learning from past patterns and reasons for recalls. This ML model utilizes both general risk indicators applicable across product categories and specific risk indicators associated with particular product categories. By incorporating user-defined risk criteria and semantically similar keywords, the present subject matter enhances the ability of the machine learning model to identify potential recall risks. As a result, the ML model may perform accurate and comprehensive risk evaluations for new products that lack their own recall history, leveraging insights gained from related product categories. This enables the manufacturers to anticipate and proactively address potential issues that may be faced by the new product, thereby saving significant time and resources associated with product recalls.

Further, the present subject matter also allows for saving significant time and enables manufacturers to bring products to market faster while maintaining a high level of safety and compliance.

Additional features and advantages are realized through the concepts of the present subject matter, including improved recall prediction capabilities, and enhanced product safety. Other embodiments and aspects of the invention are described in detail herein and are considered a part of the claimed subject matter.

### BRIEF DESCRIPTION OF FIGURES

The following detailed description references the drawings, wherein:

FIG. 1 illustrates a network environment for implementing example techniques for predicting risk of recall of a product, in accordance with an example implementation of the present subject matter.

FIG. 2 illustrates a block diagram of a product recall management system for predicting the risk of recall of the product, in accordance with an example implementation of the present subject matter.

FIG. 3 illustrates a system for implementing example techniques for predicting the risk of recall of the product, in accordance with an example implementation of the present subject matter.

FIG. 4A illustrates an exemplary interface for creating general risk indicator dictionary and specific risk indicator dictionary to be used for predicting the risk of recall of the product, in accordance with an example implementation of the present invention.

FIG. 4B illustrates an exemplary interface showing transformation of textual product recall data and risk indicator dictionaries into numerical arrays, in accordance with an example implementation of the present invention.

FIG. 5 illustrates a method for predicting risk of recall of a product, in accordance with an example implementation of the present invention.

FIGS. 6A and 6B illustrates a flow diagram of a process of predicting the risk of recall of the product and providing recommendations to mitigate the risk of recall, in accordance with an example implementation of the present invention.

FIG. 7 illustrates a flow diagram of a process of generating, by a large language model (LLM), recommendations to mitigate risk of recall of the product, in accordance with an example implementation of the present invention.

FIG. 8 illustrates a flow diagram of a process of creating training data for a machine learning (ML) model for predicting the risk of recall of the product, in accordance with an example implementation of the present invention.

FIG. 9 illustrates a computing environment for predicting risk of recall of a product, in accordance with an example implementation of the present invention.

In the figures, the left-most digits of a reference number identify the figure in which the reference number first appears. The same numbers are used throughout the drawings to reference like features and components.

### DETAILED DESCRIPTION

A product or batches of products may be subject to a recall by a manufacturer for various reasons, such as discovery of safety issues or product anomalies that may endanger consumers or put the manufacturer at risk of legal action. In some cases, a recall of a product or batches of products that are already in market may be required due to changes in regulatory requirements that may result in existing products not complying with the regulatory requirements. The recall ensures that the issues with products already in the market are addressed by removing anomalous or non-compliant products from the market or correcting the problem with the products identified to be anomalous or non-compliant.

The reasons for recall of a product may vary. For legacy products that have been available in the market for an extended period, reasons for their recall are often well-documented. These legacy products usually have a substantial history of performance data and user feedback, which may provide valuable insights into potential issues that resulted in the recall, thereby enabling manufacturers to look for issues that may cause recalls if new products with the same or similar specifications are to be launched into the market. In contrast, identifying reasons that may lead to a recall of new products for which no prior recall data is available, presents unique challenges. These challenges stem from limited to no historical data and real-world usage information. The new products may incorporate innovative technologies or materials that have not been extensively tested in various environments or conditions. This lack of comprehensive testing and real-world data may complicate the process of identifying potential issues that may lead to the recall of the new products.

Conventionally, conducting a risk assessment for a new product involves a complex and time-consuming process that relies heavily on human expertise and judgment. This process typically involves a thorough examination of product recall databases comprising extensive recall information of previously recalled products. Examples of the product recall databases may include, but are not limited to, United States Food and Drug Administration (FDA) database, United States Consumer Product Safety Commission (CPSC) database, European Medicines Agency (EMA) databases, Health Canada database, the Australian Therapeutic Goods Administration (TGA) database, National Institutes of Health (NIH) database, World Health Organization (WHO) Global Alert and Response system, European Commission's Rapid Alert System for dangerous non-food products (RAPEX), Japan's Ministry of Health, Labour and Welfare database, and the like. Additionally, the product recall databases may also include proprietary databases, for example, those maintained by the manufacturer of the products. A knowledgeable individual, often an expert in the field pertaining to the new product, is required to navigate these databases and analyse their contents in relation to the new product under consideration.

The expert may begin by identifying previously recalled products in the product recall databases that share similarities with the new product in terms of design, function, materials, compositions, or intended use. Once relevant products are identified, the expert may then have to delve into the specific reasons for their recalls, carefully studying the associated risks and issues that led to the recall decisions. This analysis may involve examining technical specifications, incident reports, trial data, and regulatory documentation to gain a comprehensive understanding of the potential hazard issues that may be associated with the previously recalled products that share similarities with the new product.

After gathering this information, the expert may then attempt to draw parallels between the previously recalled products and the new product. This process may involve assessing whether the new product shares any characteristics or components that were implicated in previous recalls. The expert may also consider whether the new product might be susceptible to similar issues or risks, even if its design or functionality differs from the recalled products.

However, this conventional approach to risk assessment may have several limitations. Firstly, it may be prone to human error. The vast amount of data in the product recall database, combined with the complexity of product specifications and recall reasons, may often makes it challenging for even experienced professionals to consistently identify all relevant information and draw accurate conclusions for the risk assessment of the new product.

Secondly, the process may be inherently subjective. Different experts may interpret the same data in varying ways, potentially leading to inconsistent risk assessments. Factors such as an individual's background, experience, and personal biases may influence their analysis and conclusions. This subjectivity may result in different experts arriving at different risk assessments for the same product, potentially leading to inconsistencies inefficiencies in decision-making and product safety evaluations.

Furthermore, the manual nature of this process may make it time-consuming and resource intensive. Thoroughly reviewing and analyzing the product recall database for each new product may require significant man-hours, potentially slowing down the product development and approval processes. This time factor may be particularly critical in industries where rapid innovation and market entry are crucial for competitiveness.

To address these challenges, attempts have been made to automate this manual process using natural language processing tools. However, these tools are unable to achieve the desired level of accuracy in risk assessment. These conventional tools often fail to provide reliable results, since they lack context awareness, potentially missing crucial nuances in product specifications or recall reasons. For example, for preempting risk of recall of a medical product, natural language processing of significant volume of recall data pertaining to previously recalled medical products needs to be carried out. Such recall data often uses domain specific terminologies, semantics of which may not be accurately interpreted by the conventional tools. As a result, the automated risk assessments carried out by these tools are not sufficiently comprehensive or reliable for making informed decisions about product safety and potential recall risks.

In light of these challenges, there may be a need for more efficient, objective, and consistent system of conducting risk assessments for new products. Such methods may potentially leverage advanced technologies to automate data analysis, reduce human error, and provide more standardized and reliable risk evaluations.

According to example implementations of the present subject matter, described herein are techniques that enable product recall risk prediction. The techniques provide to automate risk assessment processes in order to predict and mitigate product recall. These techniques may help streamline the process of predicting and mitigating product recall risks by automating the manual process of analyzing recall data. This may enhance efficiency and provide more consistent and objective evaluations of product recall risks.

In accordance with example embodiments of the present subject matter, a product recall management system (PRMS) may be operable to predict risk of recall of a product. In an embodiment, the PRMS obtains recall data pertaining to a plurality of categories of products that have been recalled in the past from at least one product recall database. The recall data includes one or more reasons for recall relating to each of the plurality of product categories. In an example, the recall data may also include product specifications, manufacturing details, quality control reports, customer complaints, incident reports, and regulatory compliance information of previously recalled product. The regulatory databases may comprise a wide range of product recall information sources, such as product recall databases implemented and maintained by various national and international regulatory bodies. In an example, the product recall database may encompass proprietary databases maintained by manufacturers or industry associations.

Further, in example embodiments, the PRMS may be configured to receive general risk indicators corresponding to the plurality of product categories from a user. A general risk indicator may be understood as a user-defined criteria for assessing risk of recall applicable across the plurality of product categories and may encompass broad considerations applicable across various product categories, such as safety concerns, performance issue, supply chain reliability, regulatory compliance. Similarly, the PRMS may receive specific risk indicators corresponding to each product category from amongst the plurality of product categories, from the user. A specific risk indicator may be understood as a user-defined criterion for assessing risk of recall of the corresponding product category and may be tailored to particular product types, addressing unique aspects of the product's design, functionality, or intended use. For example, in case of a medical device, specific risk factors may include biocompatibility, sterilization efficacy, or electromagnetic interference.

Further, in example embodiments, the PRMS may be configured to generate a list of keywords for each of the general risk indicators and specific risk indicators, a keyword comprising one or more terms semantically similar to the corresponding risk indicator. Based on the generated list of keywords, the PRMS may be configured to create a general risk indicator dictionary comprising a grouping of each of the general risk indicators with their corresponding list of keywords, and a specific risk indicator dictionary comprising a grouping of each of the specific risk indicators with their corresponding list of keywords. In an example, the list of keywords may be generated by a user or may be generated by other techniques, such as those incorporating the use of a Large Language Model (LLM). In an example, the list of keywords may include terms like “defect,” “hazard,” “malfunction,” “contamination,” “failure,” “adverse reaction,” “non-compliance”, “manufacturing error,” and “quality issue” for general risk indicators, which may be applicable across various product categories. In the case of the specific risk indicators for a given category of product, such as an MRI machine, the factors may include: “magnetic field strength fluctuations”, “image quality degradation”, “helium leakage”, “RF interference”, “patient safety concerns”, and the like. For example, a specific risk indicator like “magnetic field strength fluctuations” may have keywords including “field inhomogeneity,” “gradient instability,” “shimming errors,” and “magnetic field drift.” These specific risk indicators and their associated keywords may help the system identify and assess potential recall risks unique to categories of products similar to MRI machines.

In example embodiments, the PRMS may be configured to provide the recall data, general risk indicator dictionary, and specific risk indicator dictionary to a machine learning (ML) model, to train the ML model for predicting risk of recall of a product. The ML model is trained to determine, based on the general risk indicator dictionary and specific risk indicator dictionary, a degree of similarity between each of the general risk indicators and the specific risk indicators and the reasons for recall of products of various categories. This allows the model to recognize patterns and correlations between product attributes, risk indicators, and historical recall data. The trained ML model can then take a description of a new product as input and output an assessment indicating the likelihood of that product being recalled.

The system for predicting risk of recall of a product may provide several advantages in risk assessment techniques. By predicting potential risks associated with a product before the product is launched, manufacturers may be able to proactively address issues, potentially saving significant time and expense associated with product recalls. The automated nature of these techniques may also reduce the likelihood of human error in risk assessment processes, leading to more reliable outcomes. Further, the present subject matter also allows for saving significant time that allows companies to bring products to market faster while maintaining a high level of safety and compliance. Overall, these advantages may contribute to improved product quality, reduced recall rates, and enhanced consumer safety.

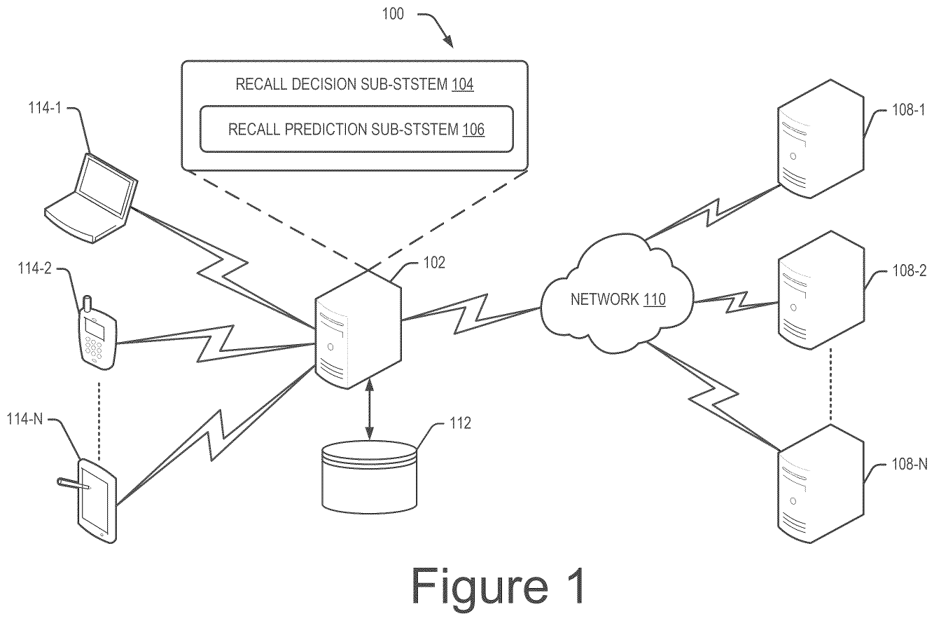

The above techniques are further described with reference to FIG. 1 to FIG. 9. It should be noted that the description and the Figures merely illustrate the principles of the present subject matter along with examples described herein and should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates a network environment 100 for implementing example techniques for predicting risks of recall of a product, in accordance with an example implementation of the present subject matter.

Recall processes are implemented in various industries, such as automotive, pharmaceuticals, consumer goods, electronics, and food production, to ensure consumer safety and compliance with regulatory standards. The recall process may also be initiated if there are concerns about the performance of the product, such as functionality issues or durability problems that do not meet the specifications of the product predefined by the manufacturer or regulatory authorities. In some instances, the recall may be a precautionary measure taken in response to potential contamination or the use of substandard materials in the manufacturing process of the product.

For products that have not yet been launched or newly launched into a market, it may be important to assess the potential risks associated with that product that may lead to a recall of the product in the future. This assessment may involve analyzing similar existing products, evaluating design specifications, and considering potential safety or regulatory concerns.

Accordingly, in accordance with example implementations of the present subject matter, a Product Recall Management System (PRMS) 102 may be implemented for assessing risk of recall of a product that is yet to be launched in the market and for which there is no prior recall history. In an example, the PRMS may be designed to align with and enforce standard operating procedures (SOPs) specific to recall processes. The SOPs outline a step-by-step process for initiating, executing, and documenting recalls in compliance with user-specified requirements and in compliance with regulatory requirements, where needed.

In an example, the PRMS 102 may be implemented and operated by a manufacturer of products to manage instances of recall of the products manufactured by the manufacturer.

In an example implementation, the PRMS 102 may comprise two primary sub-systems: a recall decision sub-system 104 and a recall execution sub-system (not illustrated in FIG. 1). The recall decision sub-system may serve as a central repository for all information pertinent to a product or batches of products that may be subject to a recall. The product may belong to one or more categories. For example, the product categories may include medical devices, pharmaceutical compositions, food, and cosmetics of various types. The recall decision sub-system may provide workflows implementing processes for the collection, updating, and maintenance of predefined information related to the products, which may be a prerequisite for any recall action to be taken. The recall execution sub-system may implement processes for the execution of the recall. In accordance with example implementations of the present subject matter, for predicting the likelihood of recall of products, such as new products for which prior recall data do not exist, a recall prediction subsystem 106 may be implemented as an additional functionality of the recall decision sub-system 104. This additional capability may enhance the decision-making process by incorporating predictive capabilities into the existing recall decision framework. The recall prediction subsystem 106, as part of the recall decision sub-system 104, may implement processes for predicting a risk of recall of a product before the product is launched into the market. By integrating predictive capabilities directly into the recall decision sub-system 104, the PRMS 102 may provide more comprehensive and proactive risk assessment, enabling better-informed decisions regarding potential recalls and preventive measures.

Although the recall prediction sub-system 106 is implemented as an additional functionality of the recall decision sub-system 104, in some implementations, the recall prediction sub-system 104 may also work independently of the other two sub-systems of the PRMS 102. For example, in cases where the recall prediction is to be done outside the PRMS 102, such as based on a directive from an investor or quality inspector of the product or in response to newly discovered information not yet within the scope of the PRMS 102.

In an embodiment, the recall prediction sub-system 106 may be configured to access one or more product recall databases 108-1, 108-2, . . . , and 108-N, for example, over a network 110, to obtain recall data pertaining to a plurality of categories of products. In some embodiments, the recall data may comprise one or more reasons for recall relating to each of the plurality of categories of the products. In some implementations, the recall data may also include product specifications, manufacturing details, quality control reports, customer complaints, incident reports, regulatory compliance information, and information on the severity and scope of previous recalls. As explained previously, the recall databases 108-1, 108-2, . . . , and 108-N may include regulatory databases from various national and international regulatory bodies, as well as proprietary databases maintained by manufacturers of the products or industry associations.

In an example, the network 110 may be a single network or a combination of multiple networks and may use a variety of different communication protocols. The network may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 110 may include various network entities, such as gateways, routers; however, such details have been omitted for the sake of brevity of the present description.

In some implementations, the PRMS 102 may include a product database 112. The product database 112 may store information about various products, including their specifications, manufacturing details, and historical data. In an example, the product database 112 may also store the recall data pertaining to each of the plurality of categories of products fetched from the one or more recall databases 108-1, 108-2, . . . , and 108-N. In an example, the product database 112 may be implemented and maintained by the manufacturer of the products to serve as a comprehensive repository for storing and managing various types of product-related information. In another example, the recall data in the product database 112 may be updated periodically. This periodic updating may involve incorporating new recall information, product specifications, and market data as they become available. The frequency of updates may vary depending on factors such as the rate of new product introductions, changes in regulatory requirements, or the occurrence of significant recall events in the industry.

Though not shown in the example implementation depicted in FIG. 1, the product database 112 may reside within the PRMS 102. Thus, example implementations where the recall data resides in a memory of the PRMS 102 are possible. Likewise, example implementations where the recall data is in an external database accessible by the PRMS 102 are also possible. The external database may be accessed by the PRMS 102 through the network 110.

The recall prediction sub-system 106 may receive, from a user, an input comprising general risk indicators and specific risk indicators corresponding to the plurality of product categories. The general risk indicators may correspond to the plurality of product categories and may be indicative of user-defined criteria for assessing risk of recall across multiple product types. For example, these general risk indicators may include factors such as safety concerns, regulatory compliance issues, or supply chain vulnerabilities that could potentially affect various product categories. The specific risk indicators, on the other hand, may correspond to each product category from amongst the plurality of product categories. These specific risk indicators may be indicative of user-defined criteria for assessing risk of recall of the corresponding product category. In an example, the specific risk indicators may include factors unique to a particular product type, such as material degradation for certain consumer goods, or biocompatibility for medical devices.

In some implementations, the user input may be provided by subject matter experts, such as scientists or industry professionals, using one or more user devices 114-1, 114-2, . . . , and 114-N. The user devices 114-1, 114-2, . . . , and 114-N may include, but are not limited to, mobile phones, tablets, computers, or other suitable electronic devices capable of interfacing with the recall prediction sub-system 106. In an example, the user devices 114-1, 114-2, . . . , and 114-N may be connected to the recall prediction sub-system 106 via the network 110.

In an implementation, the recall prediction sub-system 106 may generate a list of keywords for each of the general risk indicators and specific risk indicators. In an example, a keyword may include one or more terms semantically similar to the corresponding risk indicator. The recall prediction sub-system 106 may create a general risk indicator dictionary comprising a grouping of each of the general risk indicators with their corresponding list of keywords. The recall prediction sub-system 104 may also create a specific risk indicator dictionary comprising a grouping of each of the specific risk indicators with their corresponding list of keywords. For example, in the case of a new medical product such as a new design of pacemaker, a general risk indicator like “Safety Concerns” may have keywords including “malfunction”, “electrical failure”, and “battery issues”. A specific risk indicator for the pacemaker like “Arrhythmia Detection Accuracy” may have keywords, such as “false positives”, “missed beats”, and “sensing errors”.

In an implementation, the recall prediction sub-system 106 may provide the recall data, the general risk indicator dictionary, and the specific risk indicator dictionary to a machine learning (ML) model, to train the ML model for predicting a risk of recall of a product. For example, in the case of a new medical product such as a new pacemaker design, the ML model may be trained using historical recall data for various cardiac devices and other related medical equipment, along with the general and specific risk indicator dictionaries. The trained ML model may then be used to assess the recall risk for the new pacemaker design and features by analyzing its specifications in relation to the patterns learnt from recall data of similar categories of products and risk indicators dictionaries. In this case, the training may be based on both, the recall data as well as the two dictionaries, that have been created. The use of the dictionaries may allow the training to be more accurate as the ML model may now consider all semantically similar terms and assign them similar scores.

Thus, the present subject matter enables more accurate, comprehensive, and timely risk predictions by analyzing vast amounts of historical recall data, user-defined risk indicators, and product specifications. By integrating collaborative expert input, the system may result in increasingly refined risk assessments over time, potentially leading to improved product safety, reduced recall incidents, and more efficient recall management processes across various industries.

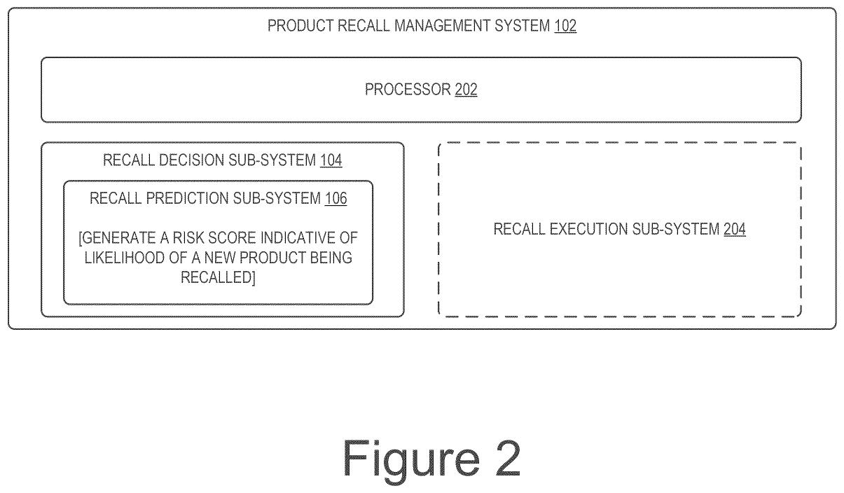

FIG. 2 illustrates a block diagram of the PRMS 102, in accordance with an example implementation of the present subject matter.

In an example, the PRMS 102 may be one or more computing devices, such as desktop computers, laptops, smartphones, personal digital assistants (PDAs), tablets, and servers.

As explained previously, product recalls are implemented across various industries to ensure consumer safety and regulatory compliance. The PRMS 102 is a tool designed to streamline the recall process for products found to be defective or non-compliant. The PRMS 102 may facilitate efficient decision-making regarding whether a recall is necessary and, if so, manages the execution of the recall process. The PRMS 102 helps manufacturers and regulators to effectively identify, track, and address potential safety issues, ensuring timely and appropriate responses to product concerns.

As explained previously, the PRMS 102 generally includes two sub-systems: a recall decision sub-system 104 and a recall execution sub-system 204 each coupled to a processor 202 of the PRMS 102. In an example, the processor 202 may be implemented as microprocessors, microcomputers, microcontrollers, digital signal processors, central processing units, state machines, logic circuitries, and/or any devices that manipulate signals based on operational instructions. The processor 202 may execute instructions stored in a memory of the PRMS 102 to accomplish functionalities of the PRMS 102.

As explained previously, the recall decision sub-system 104 aids in determining whether a recall is necessary based on various factors and data inputs, while the recall execution sub-system 204 manages the process of implementing the recall once a decision has been made. In an example implementation, these sub-systems may be provided independently. For example, a medical device regulatory agency may already have a recall decision-making process in place, but lacks a system for executing recalls across multiple healthcare providers and facilities. In this case, the medical device regulatory agency may implement only the recall execution sub-system 204 to enhance their ability to quickly and effectively manage the logistics of recalling medical devices once a decision has been made. Conversely, a medical equipment manufacturer may have a predefined recall execution process in place but may not have defined a process for determining when a recall is necessary, for example, based on analysis of data from post-market surveillance. The medical equipment manufacturer may choose to implement only the recall decision sub-system 104 to improve their ability to analyze data and make timely, informed decisions about potential recalls for their medical devices.

In accordance with an example implementation of the present subject matter, the recall decision sub-system 104 may include the recall prediction sub-system 106 to provide the recall decision sub-system 104 with an additional capability of predicting recall risks for products for which no prior recall history exists. In an example, the products for which no prior recall history exists may be considered new products or existing products which are comparatively new in the market and have not yet undergone a recall. This predictive capability may allow the manufacturers to assess and identify potential safety issues or regulatory non-compliance before they manifest in the market.

In accordance with an example implementation of the present subject matter, to predict the risk of recall of a product, the recall prediction sub-system 106 may access one or more product recall databases, such as the product recall databases 108-1, 108-2, . . . , and 108-N, to obtain recall data pertaining to the plurality of categories of products. As explained previously, the recall data may include one or more reasons for recall relating to each of the plurality of product categories. For example, in the case of medical devices, the recall data may include reasons such as software malfunction, manufacturing defects, labeling errors, or design flaws. For pharmaceutical products, the recall data may include reasons such as contamination, incorrect dosage, or unexpected side effects. In an example, the recall data corresponding to each of the plurality of product categories may be populated in the one or more databases 108-1, 108-2, . . . , and 108-N based on historical recall information from regulatory agencies, manufacturer reports, consumer complaints, and market surveillance data.

In an embodiment, the recall prediction sub-system 106 may be further configured to receive, from a user, general risk indicators corresponding to the plurality of product categories, for example, through a user device, such as a user device 114-1. In an example, a general risk indicator may be indicative of a user-defined criteria for assessing risk of recall of the plurality of product categories. In an example, the recall prediction sub-system 106 may also receive specific risk indicators corresponding to each product category from amongst the plurality of product categories from the user. In an example, a specific risk indicator may be indicative of a user-defined criteria for assessing risk of recall of the corresponding product category. In other words, the general risk indicators may apply to all product categories, while specific risk indicators are tailored to individual product categories. For example, a general risk indicator may be “manufacturing quality control,” which is relevant across various product types. On the other hand, a specific risk indicator for pharmaceutical products category may be “active ingredient purity,” which is particularly relevant to drug products.

Furthermore, in an embodiment, the recall prediction sub-system 106 may generate a list of keywords for each of the general risk indicators and specific risk indicators. In an example, a keyword may include one or more terms semantically similar to the corresponding risk indicator. Referring to the previous example, for the general risk indicator “manufacturing quality control,” the generated keywords may include “production standards,” “quality assurance,” “process control,” and “defect prevention.” Similarly, for the specific risk indicator “active ingredient purity” in the pharmaceutical products category, the generated keywords may include “chemical composition,” “contaminant levels,” “impurity profile,” and “substance integrity.” In an example, the recall prediction sub-system 106 may create a general risk indicator dictionary comprising a grouping of each of the general risk indicators with their corresponding list of keywords. In another example, the recall prediction sub-system 106 may also create a specific risk indicator dictionary comprising a grouping of each of the specific risk indicators with their corresponding list of keywords. In alternative embodiments, a single dictionary may include both the general risk indicators and the specific risk indicators, along with their corresponding keywords, providing a comprehensive reference for risk assessment across all product categories.

In an embodiment, the recall prediction sub-system 106 may provide the recall data, the general risk indicator dictionary and the specific risk indicator dictionary to a machine learning (ML) model, to train the ML model for predicting the risk of recall of a product. The trained ML model may then be used to generate a risk score indicative of the likelihood of a product, such as a new product for which no prior recall history exists, being recalled, based on the description of the new product and the learned patterns from the training data.

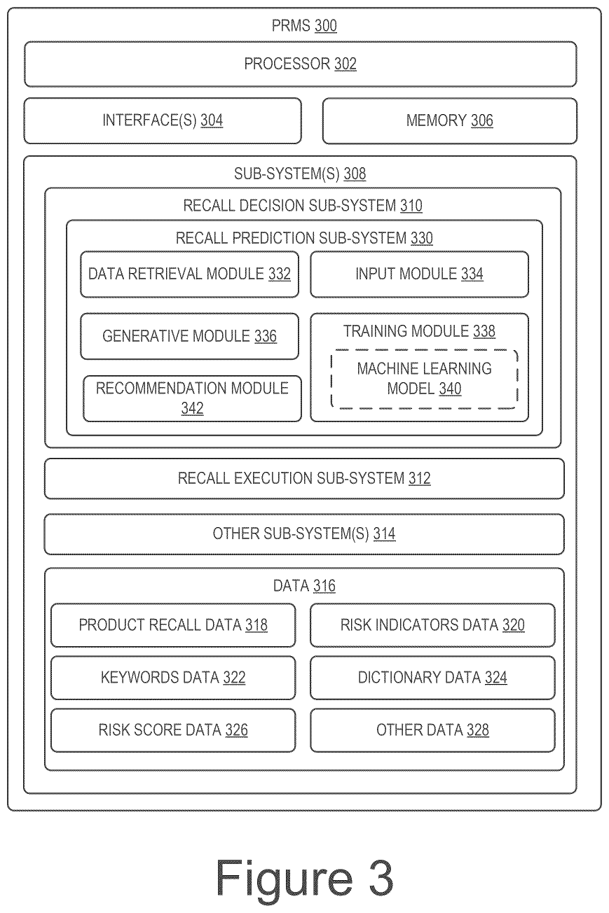

Accordingly, the present subject matter offers advantages in product recall risk assessment by combining user-defined general and specific risk indicators with historical recall data and machine learning techniques. This enables a comprehensive, customizable, and accurate risk prediction for new products for which there is no prior recall history. By leveraging semantically similar keywords and advanced machine learning models, the recall prediction sub-system 104 of the present subject matter may extrapolate potential risks from existing data to new products, providing manufacturers and regulators with valuable insights for proactive risk mitigation and improved product safety across various industries and product categories. To elaborate on the functionality of the recall prediction sub-system 106 to predict the risk of recall of a product or batches of products, reference is made to FIG. 3.

FIG. 3 illustrates a PRMS 300 that identifies, tracks, and manages the process of recalling non-compliant, defective or harmful products from the market, predicts potential recall risks for new or existing products, and enables proactive measures to mitigate future recall scenarios, for example, to ensure consumer safety and/or regulatory compliance, in accordance with an example of the present subject matter.

In an example, the PRMS 300 is similar to the PRMS 102, as explained in reference to FIGS. 1 and 2. In an example, the PRMS 300 depicted in FIG. 3 may be any computing device. Examples of the PRMS 300 may include but are not limited to servers, desktop computers, laptops, smartphones, personal digital assistants (PDAs), and tablets.

In an example, the PRMS 300 comprises a processor 302, such as the above-described processor 202. In an example, the processor 302 may be implemented as microprocessors, microcomputers, microcontrollers, digital signal processors, central processing units, state machines, logic circuitries, and/or any devices that manipulate signals based on operational instructions. In another example, the PRMS 300 also comprises interface(s) 304 coupled to the processor 302. The interface(s) 304 may include a variety of software and hardware interfaces that allow interaction of the PRMS 300 with other communication and computing devices, such as network entities, web servers, external repositories, and peripheral devices, such as input/output (I/O) devices. For example, the interface(s) 304 may couple the PRMS 300 with the product database 112 and/or the one or more user devices 114-1, 114-2, . . . , and 114-N. The interface(s) 304 may also enable coupling of internal components, if any, of the PRMS 300 with each other.

Further, the PRMS 300 comprises a memory 306. The memory 306 may include any computer-readable medium known in the art including, for example, volatile memory, such as Static Random-Access Memory (SRAM) and Dynamic Random-Access Memory (DRAM), and/or non-volatile memory, such as Read Only Memory (ROM), Erasable Programmable ROMs (EPROMs), flash memories, hard disks, optical disks, and magnetic tapes.

The PRMS 300 further includes sub-system(s) 308 and a data 316 coupled to the processor 302. In one example, the sub-system(s) 308 and a data 330 may reside in the memory 306. The sub-system(s) 308 may be implemented as a combination of hardware and programming, for example, programmable instructions to implement a variety of functionalities of the sub-system(s) 308. In examples described herein, such combinations of hardware and programming may be implemented in several different ways. For example, the programming for the sub-system(s) 308 may be executable instructions. Such instructions in turn may be stored on a non-transitory machine-readable storage medium which may be coupled either directly with the PRMS 300 or indirectly (for example, through networked means). In an example, the sub-system(s) 308 may include a processing resource of their own, for example, either a single processor or a combination of multiple processors, to execute such instructions. In the present examples, the processor-readable storage medium may store instructions that, when executed by the processor 302, implement the functionalities of the sub-system(s) 308. In other examples, the sub-system(s) 308 may be implemented as electronic circuitry.

The sub-system(s) 308 includes a recall decision sub-system 310, a recall execution sub-system 312, and other sub-system(s) 314. In an example, the recall decision sub-system 310 and the recall execution sub-system 312 are similar to the recall decision sub-system 104 and the recall execution sub-system 204, respectively, explained in reference to FIGS. 1 and 2. The other subsystem(s) 314 may further implement functionalities that supplement applications or functions performed by the PRMS 300 or any of the sub-system(s) 308 of the PRMS 300. The data 316, on the other hand, includes data that is either stored or generated as a result of functionalities implemented by the PRMS 300 or any of the sub-system(s) 308. It may be further noted that information stored and available in the data 316 may be utilized by the sub-system(s) 308 for predicting the risk of recall of a product or batches of products.

In an example, the data 316 may comprise product recall data 318, risk indicators data 320, keywords data 322, dictionary data 324, risk score data 326, and other data 328. The data 316 serves, amongst other things, as a repository for storing data that may be fetched, processed, received, or generated by one or more of the sub-system(s) 308.

In an example implementation of the present subject matter, the recall decision sub-system 310 may include a recall prediction sub-system 330 to predict risk of recall of a product or batches of products for which there may not be any existing recall data to refer to assess potential risks of recall. This predictive capability provided by the recall prediction sub-system 330 may be useful in predicting risk of recall for new products, product variations, or products entering new markets where historical recall data is limited or unavailable so that the manufacturers of such products may take corrective actions to mitigate the risk of the recall prior to launch or market entry of the product. By identifying potential issues early in the product lifecycle, the manufacturers may implement design modifications, enhance quality control measures, or adjust manufacturing processes to reduce the likelihood of future recalls. In an example, the recall prediction sub-system 330 is similar to the recall prediction sub-system 106 explained in reference to FIGS. 1 and 2.

In an embodiment, to predict the risk of recall of a product, the recall prediction sub-system 330 may be trained on recall data of similar products or products within the same category. In doing so, a data retrieval module 332 of the recall prediction sub-system 330 may be configured to access the one or more product recall databases 108-1, 108-2, . . . , and 108-N, for example, over the network 110, to obtain the recall data pertaining to a plurality of categories of products. As explained previously, the recall data may include one or more reasons recorded for past recalls of products within each of the plurality of product categories. In certain aspects, the recall data may further incorporate product specifications, manufacturing particulars, quality control assessments, consumer grievances, incident documentation, regulatory adherence details, and information regarding the magnitude and extent of these prior recalls. As explained previously, the product recall databases 108-1, 108-2, . . . , and 108-N may comprise regulatory repositories from diverse national and international regulatory entities or standard setting entities, as well as proprietary data collections maintained by product manufacturers consumer forums, or industry organizations, for instance.

In an embodiment, the data retrieval module 332 may be configured to periodically obtain updates to the recall data from the product recall databases 108-1, 108-2, . . . , and 108-N. In an example, the periodic retrieval may occur at predetermined intervals, such as daily, weekly, or monthly, depending on the frequency of updates to the product recall databases 108-1, 108-2, . . . , and 108-N or the criticality of timely information for the specific product categories. In an example, the data retrieval module 332 may employ various methods to obtain the periodic updates, including delta synchronization to only retrieve new or modified data since the last update, thereby minimizing data transfer and processing overhead. Additionally, the data retrieval module 332 may be configured to automatically adjust its retrieval frequency based on observed patterns in data updates or in response to specific triggers, such as regulatory announcements or industry alerts. In cases where real-time risk assessment is crucial, the data retrieval module 332 may also support event-driven updates, instantly fetching new recall data as soon as it becomes available in a source product recall database.

In an example, the recall data pertaining to the plurality of categories of products obtained for the product recall databases 108-1, 108-2, . . . , and 108-N may be stored in the data 316 of the PRMS 300 as the product recall data 318 for further processing.

In an embodiment, an input module 334 of the recall prediction sub-system 330 may be used to receive, for example, from a user of the recall prediction sub-system 330, general risk indicators corresponding to each of the plurality of product categories. In an example, a general risk indicator may be indicative of a user-defined criterion for assessing risk of recall that applies across multiple product categories. The general risk indicators may represent fundamental risks that manufacturing companies may need to address before releasing a product to the market, regardless of the category of the product. Example of the general risk indicators may include, but are not limited to, safety concerns, quality defects, regulatory violations, customer complaints, product recalls, supply chain risks, performance issues, adverse events, legal and liability risks, reputations risks, and the like. These general risk indicators provide a comprehensive framework for evaluating recall risk across various product categories.

Similarly, in an embodiment, the input module 334 may be used to receive specific risk indicators corresponding to each product category from amongst the plurality of product categories. In an example, a specific risk indicator may be indicative of a user-defined criterion for assessing risk of recall that is applicable to a particular product category. As the name suggests, the specific risk indicators represent unique or category-specific risks that may be relevant to products within a defined category and may not apply broadly across other categories of the product. In other words, the specific risk indicators may be tailored to specific products or product category and address unique risks associated with a particular type of product or product category. The specific risk indicators may refer to fine-grained indicators that highlight risks pertinent to specific design, manufacturing process, or usage scenarios of products or product categories in question. For example, for products in neurology category, specific risk indicators may include, but are not limited to, biocompatibility of implantable devices, accuracy of brain stimulation parameters, potential for unintended neurological side effects, sterility of invasive components, and compatibility with magnetic resonance imaging (MRI) environments. These specific risk indicators may be relevant to neurological devices but may not apply to products in other categories of products such as cardiology or orthopedics.

In various embodiments the recall prediction sub-system 330 may be trained to predict risk of recall for each of the plurality of product categories or may be trained to identify risk of recall for a specific category of products. For example, the recall prediction sub-system 330 may be trained to assess risks associated with medical devices. In this case, the recall prediction sub-system 330 may be provided with the specific risk indicators relevant to medical devices, such as biocompatibility issues, sterilization failures, software malfunctions in implantable devices, or adverse reactions to materials used in prosthetics. In an example, the recall data for such a recall prediction sub-system 330 may consist of historical recall data from medical device manufacturers, FDA reports, and expert knowledge specific to the medical device industry.

In an example, to receive the input from the user corresponding to the general risk indicators and the specific risk indicators, the input module 334 may provide a user interface (UI) on a user device, such as a user device 114-1, of the user allowing the user to input text descriptions of general and specific risk indicators, select from predefined lists of general and specific indicators, and categorize indicators as either the general risk indicators or the specific risk indicator to particular product categories. The UI may also enable users to upload existing risk assessment documents, link them to regulatory databases, and provide justifications or examples for each risk indicator.

In an example, the users who provide their inputs corresponding to the general risk indicators and the specific risk indicators may be experts in corresponding fields of product development, quality assurance, regulatory compliance, or risk management. These experts may have extensive experience in identifying and assessing potential risks associated with various product categories. In an example, the expertise of the experts may span across different industries, allowing them to provide comprehensive insights into both general and specific risk indicators. In an example, the data corresponding to general risk indicators and the specific risk indicators received from the users may be stored in the data 316 of the PRMS 300 as the risk indicators data 320.

In an embodiment, once the input from the user corresponding to the general risk indicators and the specific risk indicators is received, a generative module 336 of the recall prediction sub-system 330 may be invoked to generate a list of keywords for each of the general risk indicators and the specific risk indicators. As used herein, the term “keyword” may refer to one or more words, phrases, or terms that are semantically similar to, or conceptually related to, the corresponding risk indicator. In an example, these keywords may include synonyms, related technical terms, industry-specific jargon, or alternative expressions that may convey the same or similar meaning as the risk indicator. For example, if a risk indicator is “quality defects”, the associated keywords may include, but are not limited to, “defect,” “flaw,” “substandard,” “weaken,” “break,” “fail,” “malfunction,” “defective,” “faulty”, and the like. The use of these keywords may enhance the ability of the recall prediction sub-system 330 to identify and match relevant risk factors across various descriptions and data sources, improving the overall accuracy of risk prediction. As may be understood, the recall data may often include different words or phrases to explain reasons for recall, even when referring to similar issues. By utilizing semantically similar terms, the recall prediction sub-system 330 may effectively find matches between risk indicators and recall reasons. For example, while one recall report may use the term “defective,” another may use “faulty” or “malfunctioning” to describe a similar quality issue. The use of these semantically related keywords allows the recall prediction sub-system 330 to recognize these variations as pertaining to the same underlying risk indicator, thereby increasing the likelihood of identifying relevant patterns and correlations in the recall data. Thus, the keywords allow to bridge linguistic variations across different data sources, manufacturers, or regulatory bodies, ensuring a more comprehensive and accurate risk assessment.

In an example, the list of keywords may be generated based on user inputs. The generative module 336 may provide a UI where users, such as domain experts or risk analysts, may manually input keywords they associate with each general and specific risk indicator. This approach leverages human expertise and industry knowledge to create a set of keywords that reflect the nuances and terminology specific to particular product categories or risk indicators. In an alternative embodiment, the generative module 336 may employ one or more large language models (LLMs) to generate the list of keywords for each of the general risk indicators and the specific risk indicators. In an example, the LLMs may be trained on vast corpora of text data including industry-specific documents, technical manuals, and regulatory reports to automatically generate semantically related keywords for each of the general and specific risk indicators. This process may involve providing the risk indicator as a prompt to an LLM, which may then produce a list of related keywords based on its understanding of language and context. The LLM may capture semantic relationships and generate a comprehensive set of keywords that may not be immediately apparent to human experts. Additionally, the LLM may be fine-tuned on domain-specific datasets to improve its relevance and accuracy in generating keywords for particular industries or product categories. In an example, data corresponding to the list of keywords generated for each of the general risk indicators and the specific risk indicators may be stored in the data 316 of the PRMS 300 as the keywords data 322.

In an embodiment, the generative module 336 may create two distinct dictionaries: a general risk indicator dictionary and a specific risk indicator dictionary. In an example, the general risk indicator dictionary may be structured as a collection of entries, where each entry consists of a general risk indicator paired with its corresponding list of keywords. Likewise, the specific risk indicator dictionary may be organized in a similar manner, with each entry comprising a specific risk indicator and its associated list of keywords. For example, the general risk indicator dictionary may include entries for general risk indicators, such as “safety concerns” with associated keywords like “harm”, “toxic”, “allergic reaction”, “safety”, “danger”, “risk”, “injury”, “hazard”, “unsafe”, “poison”, etc. Similarly, the specific risk indicator dictionary may include specific risk indicator entries for particular product categories. For example, an entry for neurology products may include keywords like “neurological side effects,” “seizures,” or “cognitive impairment”, etc. This approach of creating the dictionaries ensures that the dictionaries encompass a wide range of potential risks associated with each product category, thereby enabling efficient mapping between the risk indicators and relevant keywords to facilitate more accurate identification of potential risks in product descriptions and recall data. In an example, data corresponding to the general risk indicator dictionary and the specific risk indicator dictionary may be stored in the data 316 of the PRMS 300 as the dictionary data 324.

In an embodiment, a training module 330 of the recall prediction sub-system may include a machine learning (ML) model 340 that may be trained to predict risk of recall of a product.

In doing so, the training module 330 may first transform both, the product recall data 318 that includes the past reasons for recalls of similar or related products, and the dictionary data 324 that includes the general risk indicator dictionary and the specific risk indicator dictionary that are present in the form of text into numerical arrays in order to facilitate processing by the ML model 340.

In an example, in order to transform textual information included in the product recall data 318 and the dictionary data 324 into numerical arrays, an embedding technique, such as word2vec or BERT, may be used. In other implementations, other known embedding technique may also be used, but these have not been mentioned here for brevity. This embedding converts text included the product recall data 318 and the dictionary data 324 into arrays of numbers, enabling computational analysis.

Thereafter, a risk score may be calculated between the reason for recall and each individual risk indicator based on a degree of similarity between the corresponding risk indicator and the one or more reasons for recall of each of the plurality of product categories. For the purpose, the risk factors within each reason for recall may be digitized, resulting in a structured dataset that represents the digitalized version of the recall reasons based on the defined risk indicators. The mapping transforms the textual representation of recall reasons into a multi-dimensional space spanned by the risk indicators. The coordinates within this space correspond to the similarity between the reason for recall and each specific risk indicator.

In an example, in calculating the risk score, risk factors included in the reasons for recall in the product recall data 318 that contributed to the recall of the products may be mapped with at least one of the risk indicators or keywords linked to the risk indicator if no direct reference to the risk indicator is available in the risk factors. For instance, a reason for recall may include the following text: “Bio-logical System Corp Camera Pole may weaken after extended use”. A risk factor in this reason for recall may be “weaken,” which may be mapped to the risk indicator “quality defects” even though “quality defects” is not directly mentioned in the reason for recall. This mapping occurs because “weaken” is one of the keywords associated with the “quality defects” risk indicator in the general risk indicator dictionary. Thus, associating keywords with the indicators may enhance accuracy of the risk score that quantifies the correlation between the reason for recall and the predefined risk indicators. In an example, dataset created by the transformation of the product recall data 318 and the dictionary data 324 may be stored in the data 316 of the PRMS 300 as the risk score data 326.

In an embodiment, the risk score data 326 created by the transformation of the product recall data 318 and the dictionary data 324 into numerical arrays may be provided as training data to the ML model 340. In an example, the risk score data 326 may be divided into training, validation, and testing subsets using a stratified sampling technique, such as proportional allocation or optimal allocation, ensuring balanced representation of diverse characteristics in each subset. In an example, the training subset may be used to transform the ML model 340 into a multioutput regression machine learning model that correlates product descriptions with their respective risk scores. The validation subset helps refine parameters of the ML model 340 for optimal accuracy, while the testing subset may assess performance of the ML model 340 on unseen data. This process enables the ML model 340 to estimate risk scores based on inputted product descriptions, serving as a tool for proactive risk management workflows.

In case of a new product under scrutiny, the predictive capabilities of the ML model 340 may be utilized to determine risk of recall of the new product. In an example, to determine the risk of recall associated with the new product, a user who wishes to assess the risk of recall of the new product may provide a description of the product to the ML model 340, for example, through the UI of the input module 334 using the user device 114-1. In an example, the product description may include details such as the category of the new product, materials used, manufacturing process, intended use, and any specific features or components.

In an example, utilizing the product description, the ML model 340 may generate a risk score associated with each of the predefined risk indicators for the new product. In doing so, the ML model 340 may process the product description by converting the product description into a numerical representation compatible with input format of the ML model 340. The ML model 340 may then analyze this representation against the patterns learned from historical recall data to estimate the likelihood of each risk indicator being applicable to the new product. The ML model 340 may consider factors such as similarities between the new product and previously recalled products, the prevalence of certain risk factors in the category to which the new product belongs, and the correlation between specific product features and historical recall reasons. The output of the ML model 340 may be a set of risk scores, each corresponding to a predefined risk indicator, quantifying the potential risk of recall associated with the new product. In an example, the risk indicator with a highest risk score may indicate the most probable cause for a potential recall of the new product.

In an embodiment, the output of the ML model 340 may be provided to a recommendation module 342 of the recall prediction sub-system 330. In an example, the recommendation module 342 may include an LLM that may analyze the predicted risk indicators applicable to the new product and their corresponding scores to elucidate the results. The LLM may evaluate the potential recall risks associated with the new product and generate a comprehensive assessment summary that includes detailed explanations of each identified risk, its potential impact on product safety, and its relative importance based on the risk score.

In an example, the recommendation module 342 may generate one or more recommendations regarding whether the new product may proceed to approval, along with strategies to mitigate the identified risks and prevent potential recalls. These recommendations may include suggested modifications to product design, changes in manufacturing processes, additional quality control measures, or specific safety features to be incorporated. The LLM may also provide context-specific advice based on historical recall data and industry best practices, offering actionable insights to improve product safety and reduce recall likelihood. In an example, the LLM may be trained on historic data comprising records of actions taken regarding previously recalled products. In an example, for LLM to be able to generate the relevant recommendations, the LLM may be trained on historic data comprising records of actions taken regarding previously recalled products.

Accordingly, the present subject matter provides for combining machine learning models and large language models to reduce recall risks. The present subject matter also provides accurate risk prediction through analysis of historical recall data, comprehensive risk assessment using multiple indicators, and actionable recommendations for risk mitigation. The present subject matter uses customizable risk indicator dictionaries, enabling tailored risk assessments for different industries and product types. By leveraging historical data and continuously learning from new information, the invention enables data-driven decision-making and ensures ongoing improvement in risk prediction and mitigation strategies.

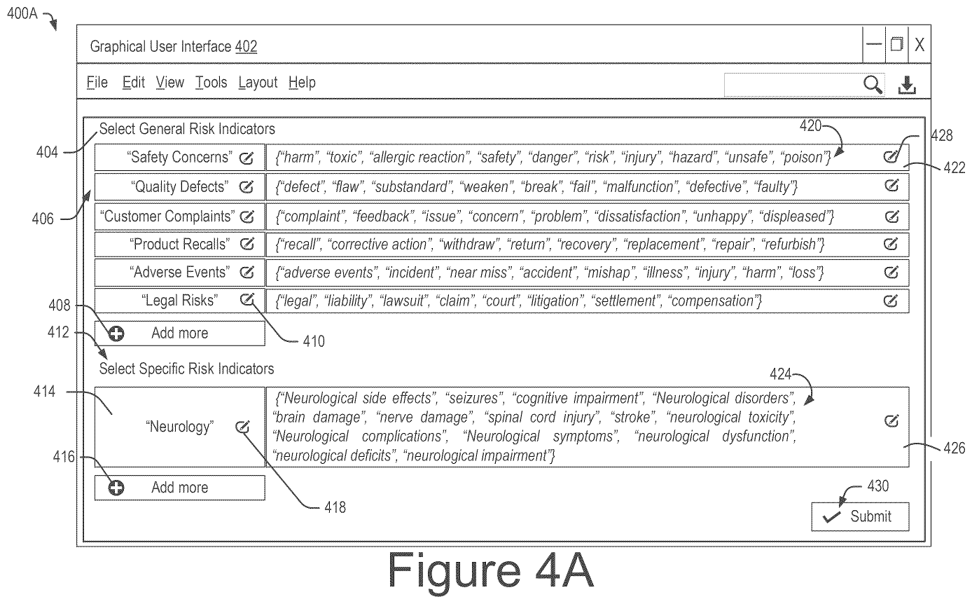

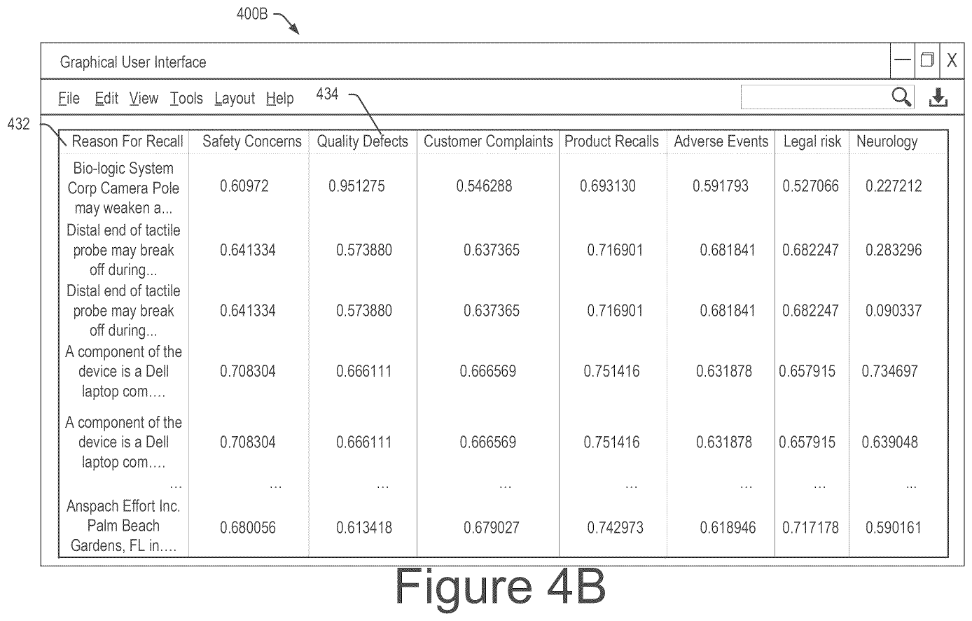

FIG. 4A illustrates an exemplary interface 400A of the recall prediction sub-system 330 for creating the general risk indicator dictionary and the specific risk indicator dictionary to be used in predicting the risk of recall of a product, such as a new product, for which there is no prior recall data available, in accordance with an example implementation of the present invention. The embodiments of the interface 400A illustrated in FIG. 4A are for illustration only. FIG. 4A does not limit the scope of this disclosure to any particular implementation.

As explained previously, to predict the risk of recall for a new product with no prior recall data, the recall data from similar product categories may be utilized. The recall data of the similar product categories may pertain to products that share characteristics with the product for which the risk of recall is to be predicted. These similar products categories may have been in the market for an extended period of time and the recall data for such product categories may have been captured in various public and/or private product recall databases, such as the product recall databases 108-1, 108-2, . . . , 108-N. The existing recall data for such similar product categories may be relied upon to assess the risk for recall for the new product.

For a machine learning (ML) model, such as the ML model 340, to be able to predict the risk of recall of a product based on the recall data of similar product categories, the ML model 340 may need to be trained to identify and extract relevant information from the recall data. For the purpose, as described above, the general risk indicator dictionary and the specific risk indicator dictionary may be created. In an example, the general risk indicator dictionary may contain general risk indicators applicable to multiple product categories, while the specific risk indicator dictionary may focus on specific risk indicators unique to particular product categories or industries. By utilizing these dictionaries, the ML model 340 may learn to recognize patterns, correlations, and risk factors associated with product recalls, enabling the ML model 340 to make more accurate predictions regarding the risk of recall for the new products.

In an embodiment, to create the general risk indicator dictionary and the specific risk indicator dictionary, the general risk indicators and the specific risk indicators may be received as input from the user of the recall prediction sub-system 330, for example, through the user device 114-1. As explained previously, the user may be an expert in the field, such as a product safety specialist, quality control manager, or regulatory compliance officer, who possesses knowledge about potential risks associated with various product categories. This expert user may leverage their experience and industry insights to identify and input the general risk indicators and the specific risk indicators that are commonly associated with product recalls across multiple categories and within specific product categories, respectively.

In an embodiment, to receive the user input, the input module 334 of the recall prediction sub-system 330 may present a GUI 402 upon user request by the user to access the recall prediction sub-system 330. As shown in FIG. 4A, the GUI 402 may provide the user with an interface for entering the general risk indicators in a general risk indicators selection section 404. These general risk indicators may include broad categories of risk indicators, such as “Safety Concerns”, “Quality Defects”, “Customer Complaints”, “Product Recalls”, “Adverse Events”, “Legal Risks”, and the like, that may be common to broad categories of products. Each general risk indicator entered by the user may be displayed in a risk indicator row 406, which may include a risk indicator name, such as the “Safety Concerns” as shown in FIG. 4A. The GUI 402 may allow the users to manage these risk indicators by adding new risk indicators through an add button 408 or edit existing ones via an edit button 410 provided against each risk indicator row entered by the user.

Similarly, in an embodiment, to receive the user input pertaining to the specific risk indicators, the GUI 402 may provide the user with an interface for entering the specific risk indicators in a specific risk indicators section 412. In an example, the specific risk indicators may include risk indicators that may be applicable specifically to particular product categories. For example, as shown in FIG. 4A, a specific risk indicator “Neurology” that may be applicable to neurological product categories is displayed in a specific risk indicator row 414. These specific risk indicators may be tailored to address risks that are more relevant to certain product types or sectors, allowing for a more nuanced and targeted risk assessment. In an example, the users may add new specific risk indicators using an add more button 416 or edit existing ones using an edit button 418 provided against the specific risk indicator entered by the user in the specific risk indicator row 414.

In an alternative embodiment, each of the general risk indicators and the specific risk indicators may be generated by a large language model (LLM) trained based on historical recall data, industry reports, and expert knowledge. In an example, the general risk indicators and the specific risk indicators generated by the LLM may be vetted by the user before submission. The user may review, modify, or approve the LLM-generated risk indicators through the interface provided by the GUI 402 before the LLM generated risk indicators are incorporated into the recall prediction sub-system 330.

Further, in an embodiment, each of the general risk indicators and specific risk indicators may be linked with a list of semantically similar keywords. These keywords are provided to enhance the ability of the ML model 340 to identify and associate relevant information from the recall data with the corresponding risk indicators. The keywords may include synonyms, related terms, or specific phrases that are commonly associated with the particular risk indicator but may not be available in the reason for recall recorded in the recall data. As explained previously, this expanded set of keywords may capture industry-specific jargon, technical terms, colloquial expressions, or emerging terminology that may not be standardized in the recall data. For example, as shown in FIG. 4A, for the general risk indicator named “Safety Concerns”, a list of keywords 420 is shown in a general risk indicator keywords field 422. For the specific risk indicator named “Neurology”, a list of keywords 424 is shown in a specific risk indicator keywords field 426. As shown in the general risk indicator keywords field 424, the risk indicator named “Safety Concerns” may be associated with the keywords like “harm”, “toxic”, “allergic reaction”, “safety”, or “danger”, which may not be explicitly stated in the reasons for recall recorded in the recall data of the products of similar categories but are indicative of safety concerns. Similarly, shown in a specific risk indicator keywords field 426, the specific risk indicator named “Neurology” may be associated with the keywords like “Neurological side effects”, “seizures”, “cognitive impairment”, “Neurological disorders”, “brain damage”, and the like.

In an example, to generate the list of keywords that are semantically similar to corresponding general risk indicators and specific risk indicators, the user who may be the expert in the field may input the keywords directly through the GUI 402. The knowledge and experience of the expert may be leveraged to create a comprehensive and relevant list of keywords for each risk indicator. In another example, to generate the list of keywords, a LLM may be used that may be trained using historical recall data, industry reports, scientific literature, and expert-curated datasets. The LLM may analyze patterns, context, and relationships within this training data to generate a diverse set of semantically related keywords for each risk indicator. In an example, the recall prediction sub-system 330 may then present these LLM-generated keywords to the user through the GUI 402 for review, modification, or approval, to ensure a balance between automated efficiency and human expertise in the keyword generation process. The user may edit the keywords generated by the LLM through the GUI 402, for example, using an edit button 428 provided in each risk indicator keywords field. By incorporating this broader vocabulary, the ML model 340 may improve its ability to identify potential risks even when the recall data uses varied or non-standard language to describe issues. This may also be useful in capturing evolving risk indicators or regional variations in terminology, thereby improving the adaptability and accuracy of the ML model 340 in risk prediction across diverse product categories and markets.

Once the general risk indicators and specific risk indicators, along with their respective keyword lists, are entered into the GUI 402, the user may submit data corresponding to the general risk indicators, specific risk indicators, and their respective keyword lists populated in the GUI 402 via a submit button 430. Upon submission, the recall prediction sub-system 330 may generate two separate dictionaries: the general risk indicator dictionary and the specific risk indicator dictionary. These dictionaries include the risk indicators and their associated semantically similar keywords, that may be provided as a training data to the ML model 340.

The general risk indicator dictionary and the specific risk indicator dictionary so created encompass a wide range of potential risks associated with each product type. Creating separate general and specific risk indicator dictionaries may allow for the identification of subtle or emerging risks, provides a framework for continuous improvement, and enhances the interpretability of risk predictions.

FIG. 4B illustrates an exemplary interface 400B showing transformation of textual product recall data and risk indicator dictionaries into numerical arrays, in accordance with an example implementation of the present invention.

As explained previously, the training module 330 of the recall prediction sub-system may include the ML model 340 that may be trained to predict risk of recall of a product. In an embodiment, the ML model 340 may be external to the recall prediction sub-system 330, implemented as a standalone module or service and communicatively coupled to the recall prediction sub-system 330. In an example, the standalone ML model 340 may be accessed by the recall prediction sub-system 330, for example, over the network 110.

As explained previously, to train the ML model 340, the product recall data 318 that includes the recall data and the dictionary data 324 that includes the data corresponding to the general risk indicator dictionary and the specific risk indicator dictionary may be used. In an example, to prepare the product recall data 318 and the dictionary data 324 for the ML model 340, the training module 330 may perform a transformation process of the product recall data 318 and the dictionary data 324. In an example, this process may convert the data included in the product recall data 318 and the dictionary data 324 into numerical arrays. By converting these text-based data sources into numerical arrays, the training module 330 enables efficient processing and analysis by the ML model 340.

To convert the textual information within the product recall data 318 and the dictionary data 324 into numerical arrays, the training module 330 may employ an embedding technique. Examples of such techniques include word2vec or BERT, although other embedding methods may also be utilized. In an example, the choice of the embedding technique may depend on factors such as the specific requirements of the ML model 340, the nature of the textual data, and the desired performance characteristics.

In an example, as explained previously, after embedding, the training module 330 may calculate risk scores between the reasons for recall and risk indicators by measuring their similarity. This process digitizes risk factors, transforming textual data into a multi-dimensional space. Risk scores are calculated using metrics like cosine similarity or Euclidean distance, normalized to a standard range, providing quantitative measures for analysis by the ML model 340.

In an example, when calculating the risk score, the training module 330 may map risk factors from the product recall data 318 to risk indicators or their associated keywords. This mapping may occur even when the risk indicator is not directly mentioned in the reasons for recall. For example, as shown in FIG. 4B, in a first column 432 that includes reasons for recall, a first reason for recall mentions “Bio-logical System Corp Camera Pole may weaken after extended use.” In this reason for recall, the term “weaken” may be mapped to the risk indicator “Quality Defects” mentioned in a third column 434 based on keyword associations in the general risk indicator dictionary. This is because, although the first reason for recall has no direct mention of the risk indicator “Quality Defects”, the term “weaken”, as indicated in FIG. 4A, is linked with the risk indicator “Quality Defects” in the general risk indicator dictionary. The ML model 340 may recognize this indirect relationship, allowing for a more comprehensive risk assessment. This mapping enables the calculation of a risk score that reflects the similarity between the recall reason and the “Quality Defects” risk indicator, even when the risk indicator “Quality Defects” is not explicitly stated in the reason of recall. This enhances the accuracy of risk scores by capturing indirect relationships between recall reasons and predefined risk indicators. The resulting dataset, created from transforming the product recall data 318 and the dictionary data 324, may be stored as the risk score data 326 in the memory 406 of the PRMS 300 to be used in the training of the ML model 340.

In an embodiment, the risk score data 326, derived from transforming the product recall data 318 and dictionary data 324 into numerical arrays, serves as the training data for the ML model 340. In an example, the risk score data 326 may be divided into training, validation, and testing subsets using stratified sampling techniques like proportional or optimal allocation, ensuring balanced representation across subsets. The training subset may be used to develop the ML model 340 into a multioutput regression model that correlates product descriptions with risk scores. The validation subset may help optimize parameters of the ML model 340, while the testing subset may evaluate performance of the ML model 340 on unseen data. This process enables the ML model 340 to estimate risk scores from inputted product descriptions, facilitating proactive risk management. The ability of the ML model 340 to learn from historical data and apply to new products enhances its utility in predicting potential risks associated with various product descriptions. For example, when presented with a new medical product description for a telescoping camera pole assembly designed for use with specific camera systems, the ML model 340 may identify risk factors based on similarity scores from the recall data, such as those accessed from the FDA databases. The ML model 340 may predict the highest risk factor as product recalls (similarity score 0.693), followed by safety concerns (0.609), adverse events (0.591), legal and liability risks (0.564), and quality defects (0.561). Conversely, the ML model 340 may assign a low risk score (0.0) to neurology-related issues, indicating minimal recall risk in this area.

Further, the risk score against each risk indicator generated by the ML model 340 may be provided to the recommendation module 342. The recommendation module 342 may analyze these risk scores and generate a risk assessment summary along with specific recommendations for risk mitigation. In an example, recommendation module 342 may include a LLM trained to translate the numerical risk scores into actionable insights. For example, when presented with the risk scores for a new telescoping camera pole assembly, LLM of the recommendation module 342 may generate a recommendation stating that due to high similarity scores for risk indicators the product recalls (0.693) and the safety concerns (0.609), it is recommended that the product undergo further testing and review before it is approved for use. The recommendation may include a note suggesting that the product should undergo rigorous safety testing and quality control checks to ensure that the product meets all necessary safety and quality standards. The recommendation may also state that to avoid potential recalls, the manufacturer may ensure that the product is in full compliance with all the regulatory requirements. This includes ensuring that the product is properly labeled, and that all necessary documentation is in place.

This granular risk assessment enables proactive risk mitigation strategies tailored to the specific product characteristics and historical recall patterns.

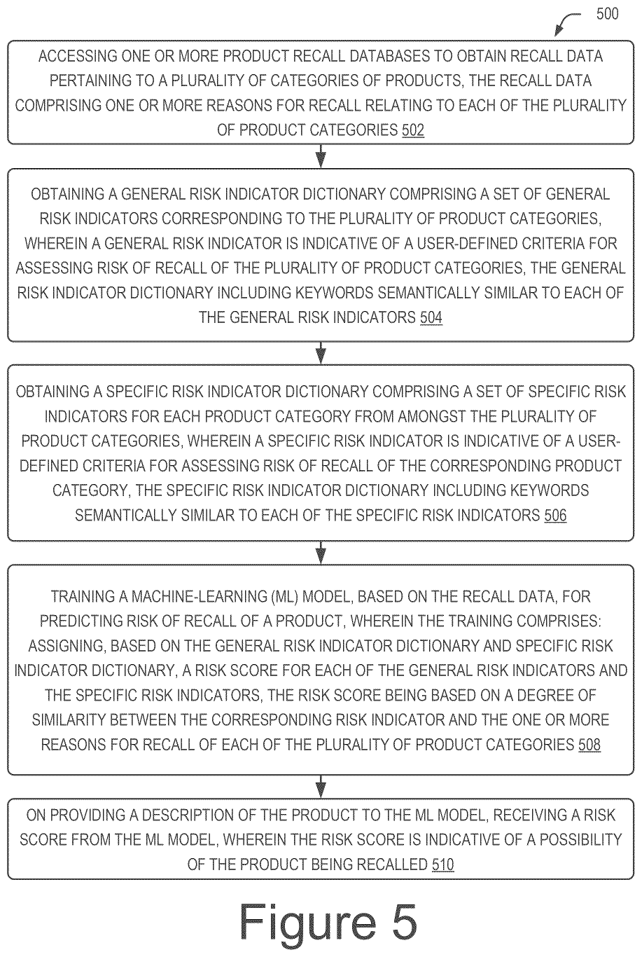

FIG. 5 illustrates a method 500 for predicting risk of recall of a product, according to an example implementation of the present subject matter. Although the method 500 may be implemented in a variety of computer-based systems, for ease of explanation, the present description of the example method 500 for predicting risk of recall of a product is provided in reference to the above-described system 102, 300.

The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof.

It may be understood that blocks of the method 500 may be performed by programmed computing devices. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

As explained previously, for a new product, it is often difficult to identify all potential reasons that may lead to a recall of the product. While some general recall reasons may be anticipated beforehand, specific issues, such as those related to the unique design of the product, manufacturing processes, and distribution channels may remain unknown until the product is in the market. The novelty of the product may introduce unforeseen risks at various stages. For example, innovative design elements may have unintended safety implications, new manufacturing techniques used in the production of the product may lead to unexpected quality control problems potentially resulting in recall of the product, and novel distribution methods may impact product integrity in ways not previously considered. Consequently, while some recall reasons may be predicted, the unique aspects of a new product often entail unknown risks that may only become evident through real-world use. Thus, specific reasons for recall of the products that manifests only through real-world use of the products may not be available for a new product that is either yet to be introduced to the market or has been recently introduced. This absence of the prior recall data for the new product may make it challenging for the manufacturers or other interested parties, such as regulatory bodies, to assess the risk of recall associated with such a new product.

Accordingly, at block 502, to predict a risk of recall of a product that may manifest only through real-world use, one or more product recall databases, such as the product recall databased 108-1, 108-2, . . . 108-N, may be accessed to obtain recall data pertaining to a plurality of categories of products. The recall data may include one or more reasons for recall of each of the plurality of product categories of products. As explained previously, in an example, the recall data may also include product specifications, manufacturing details, quality control reports, customer complaints, incident reports, and regulatory compliance information of previously recalled product. In examples, the recall data may be extracted from regulatory databases comprising a wide range of product recall information sources, that are implemented and maintained by various national and international regulatory bodies. In an example, the product recall database may also encompass proprietary databases maintained by manufacturers or industry associations.

At block 504, a general risk indicator dictionary comprising a set of general risk indicators corresponding to the plurality of product categories may be obtained. In an example, a general risk indicator may be indicative of a user-defined criteria for assessing risk of recall of the plurality of product categories. In some examples, the general risk indicator dictionary may include keywords semantically similar to the corresponding general risk indicators. As explained previously, in an embodiment, these general risk indicators may be applicable across various product categories.

At block 506, a specific risk indicator dictionary comprising a set of specific risk indicators for each product category from amongst the plurality of product categories may be obtained. In an example, a specific risk indicator may be indicative of a user-defined criteria for assessing risk of recall of the corresponding product category. In some examples, the specific risk indicator dictionary may include keywords semantically similar to each of the specific risk indicator.

At block 508, a machine-Learning (ML) model, such as the ML model 340, may be trained, based on the recall data, for predicting risk of recall of a product. In an example, the training may include assigning, based on the general risk indicator dictionary and specific risk indicator dictionary, a risk score for each of the general risk indicators and the specific risk indicators. The risk score may be based on a degree of similarity between the corresponding risk indicator and the one or more reasons for recall of each of the plurality of product categories.

As explained previously, the product for which the risk of recall is to be predicted may be a new product that may not correspond to any of the products in the plurality of product categories and for which no recall information may be available in the recall databases. The novelty of the new product owing to features not present in previously available products may make it challenging for the manufacturer of the new product foresee if a likelihood of recall exists for the new product. The trained ML model may provide for predicting the risk of recall of the new product. Accordingly, at block 510, on providing a description of the product to the ML model, a risk score may be received from the ML model 340. In an example, the risk score may be indicative of a possibility of the product being recalled.

In an example, the risk score may be expressed as a numerical value or percentage, providing a quantitative assessment of the likelihood of a recall. The risk score is based on analyzing the features of the new product relative to other products, of which recall information is made available to the ML model 340 in the training phase, that have similar if not identical features. If a previously available product was recalled owing to issues relating to such similar features the risk score maybe high. The risk score may allow the manufacturers to take risk mitigation efforts. For example, a high risk score may prompt additional testing, design modifications, or enhanced quality control measures before the product is released to market. Conversely, a low risk score may indicate that the risk indicator against which the ML model 340 has provided a low risk score has a low probability of causing recall of the product. This information may be valuable for prioritizing risk mitigation efforts and allocating resources effectively in product development and quality assurance processes.

Thus, the example method 500 may utilize the recall data of the existing products that are in the market for a longer period of time for predicting and assessing risks of potential recalls for new products before they are launched in the market or soon after the launch. This may allow the manufacturers to proactively identify and mitigate potential issues, potentially reducing the likelihood and impact of future recalls.

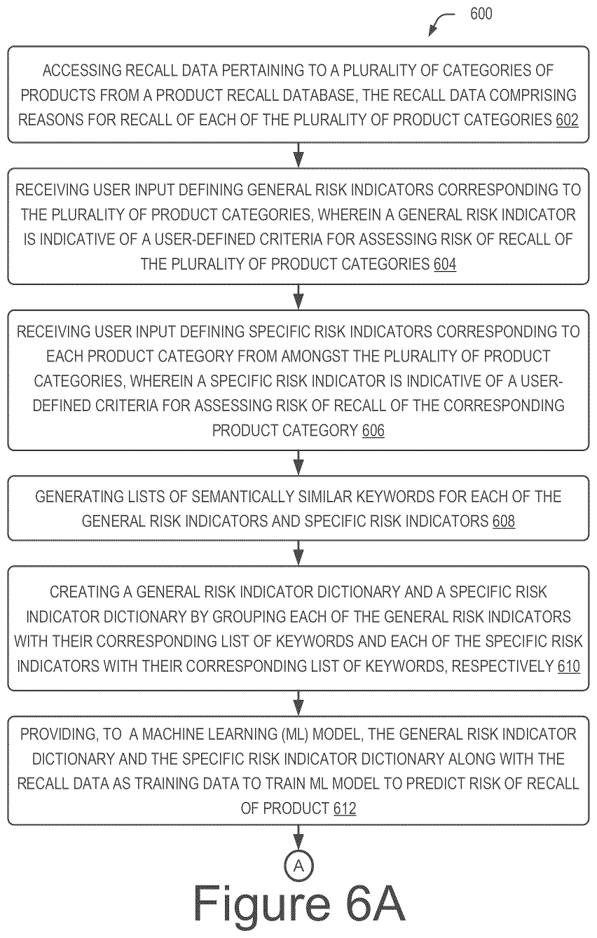

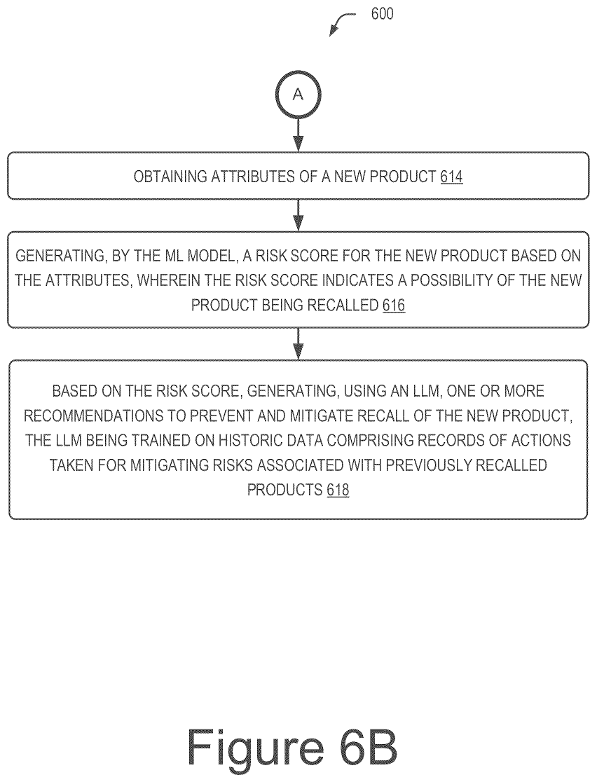

FIGS. 6A and 6B illustrates a flow diagram of a process 600 for implementing example techniques for predicting risk of recall of a product and providing recommendations to mitigate the recall risk, in accordance with an example implementation of the present subject matter. The order in which the above-mentioned process is described is not intended to be construed as a limitation, and some of the described process blocks may be combined in a different order to implement the process, or an alternative process.

Furthermore, the above-mentioned process 600 may be implemented in suitable hardware, computer-readable instructions, or a combination thereof. The steps of such a process may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods. In an example, the process 600 may be implemented by the system 102, 300 of FIGS. 1-4.

Referring to FIGS. 6A & 6B, at block 602, recall data pertaining to a plurality of categories of products may be accessed, for example, at the recall prediction sub-system. The recall data may comprise one or more reasons for recall associated with each of the plurality of product categories.

At block 604, a user input defining general risk indicators corresponding to the plurality of categories of products may be received. As explained previously, a general risk indicator may be understood as a user-defined criteria for assessing risk of recall applicable across the plurality of product categories and may encompass broad considerations applicable across various product categories, such as safety concerns, performance issue, supply chain reliability, regulatory compliance.

At block 606, a user input defining specific risk indicators corresponding to each product category from amongst the plurality of product categories. As explained previously, a specific risk indicator may be understood as a user-defined criteria for assessing risk of recall of the corresponding product category and may be tailored to particular product types, addressing unique aspects of the product's design, functionality, or intended use.

At block 608, lists of semantically similar keywords for each of the general risk indicators and specific risk indicators may be generated. For example, in pharmaceutical industry, a general risk indicator of “contamination” may have keywords like “impurities,” “microbial growth,” and “foreign particles,” while a specific risk indicator for injectable drugs might be “sterility,” with keywords such as “endotoxin presence,” “particulate matter,” and “packaging integrity issues.”

At block 610, a general risk indicator dictionary and a specific risk indicator dictionary may be created by grouping each of the general risk indicators with their corresponding list of keywords and each of the specific risk indicators with their corresponding list of keywords, respectively. As explained previously, in an example, the list of keywords may include terms like “defect,” “hazard,” “malfunction,” “contamination,” “failure,” “adverse reaction,” “non-compliance”, “manufacturing error,” and “quality issue” for general risk indicators, which may be applicable across various product categories. In the case of the specific risk indicators for a given category of product, such as an MRI machine, the list of keywords may include: “magnetic field strength fluctuations”, “image quality degradation”, “helium leakage”, “RF interference”, “patient safety concerns”, and the like.

At block 612, the general risk indicator dictionary and the specific risk indicator dictionary along with the recall data may be provided to a Machine Learning (ML) Model as training data to predict risk of recall of product. As explained previously, the training may comprise assigning a risk score to each general and specific risk indicator, based on the general risk indicator dictionary and specific risk indicator dictionary. The risk score may be determined by evaluating the degree of similarity between the reasons for recall from the recall data and the corresponding risk indicators for each product category.

At block 614, attributes of a new product may be obtained. As used herein, the term “new product” may refer to a product that has not yet been released to the market or has been recently introduced and lacks substantial historical data. In an example, the term “attributes” may encompass various characteristics, specifications, and features of the new product. These attributes may include, but are not limited to, physical properties, functional capabilities, materials used, manufacturing processes, intended use, target market, and regulatory classifications. In some cases, attributes may also include information about the product's development process, quality control measures, and compliance with industry standards.

At block 616, a risk score for the new product may be generated by the ML model based on the attributes. The risk score indicates a possibility of the new product being recalled. In an example, the risk score may be expressed as a numerical value or percentage, providing a quantitative assessment of the likelihood of a recall. The risk score may be based on analyzing the features of the new product relative to other products with similar attributes that were included in the training data.

At block 618, based on the risk score, one or more recommendations may be generated by a LLM to prevent and mitigate recall of the new product, the LLM being trained on historic data comprising records of actions taken for mitigating risks associated with previously recalled products.

In the method 600, blocks 602 to 612 may be considered part of the training phase, where the ML model is prepared and trained to predict recall risks. During this phase, historical data is collected, risk indicators are defined, and the model learns patterns from past recalls. The deployment phase may encompass blocks 614 to 618, where the trained model is applied to assess new products. In this phase, the model utilizes the knowledge gained during training to evaluate potential risks for products that have not yet been released to the market. This two-phase approach may allow for continuous improvement of the risk prediction capabilities as new data becomes available and the model is periodically retrained.

The method 600 may offer several technical advantages for predicting and mitigating product recall risks. By leveraging general risk indicators and the specific risk indicators along with the recall data, the method may enable more accurate and comprehensive risk assessments. Additionally, the two-phase approach of training and deployment may facilitate continuous improvement of the risk prediction capabilities as new data becomes available. The method's ability to generate tailored recommendations based on the predicted risk score may provide manufacturers with actionable insights to proactively address potential issues before product launch, potentially reducing the likelihood and impact of recalls.

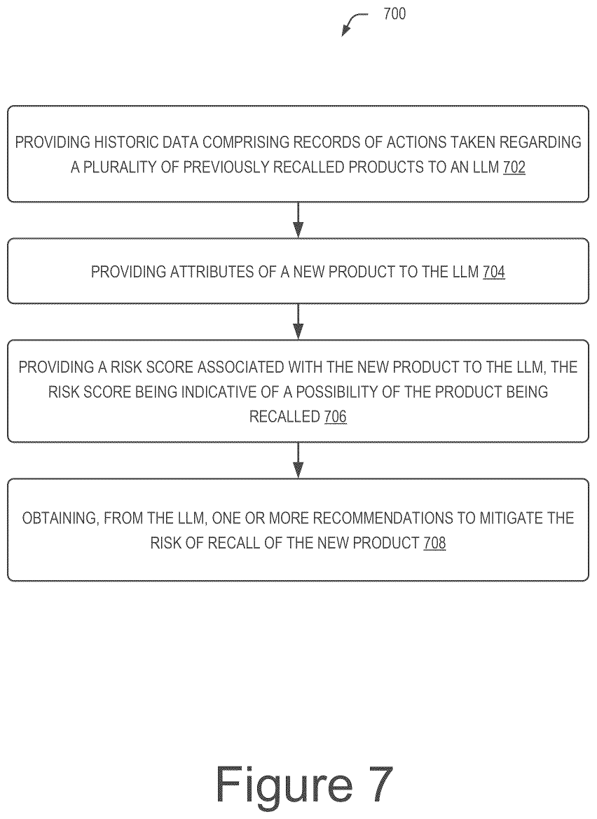

FIG. 7 illustrates a flow diagram of a process 700 for training an LLM for implementing example techniques for providing one or more recommendations to mitigate risk of recall of a product, in accordance with an example implementation of the present subject matter. The order in which the above-mentioned process is described is not intended to be construed as a limitation, and some of the described process blocks may be combined in a different order to implement the process, or an alternative process.

Furthermore, the above-mentioned process 700 may be implemented in suitable hardware, computer-readable instructions, or a combination thereof. The steps of such a process may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods. In an example, the process 700 may be implemented by the system 102, 300 of FIGS. 1-4.

The method 700 may be implemented in conjunction with or as an extension of the method 500 described earlier. While method 500 focuses on predicting the risk of recall for a product, method 700 may build upon this by providing recommendations to mitigate the predicted risk. This integration allows for a comprehensive approach to product recall management, combining risk assessment with actionable mitigation strategies. Additionally, the method 700 may provide further details on block 618 of method 600, expanding on the process of generating recommendations to prevent and mitigate recall risks.

At block 702, historic data comprising records of actions taken regarding a plurality of previously recalled products may be provided to a Large Language Model (LLM). This data may include detailed information about past recalls, such as the reasons for the recalls, the steps taken to address the issues, and the outcomes of these actions. By feeding this information to the LLM, the model may learn patterns and effective strategies for mitigating recall risks across various product categories.

At block 704, attributes of a new product may be provided to the LLM. These attributes may include specifications, features, and other relevant characteristics of the product. The LLM may analyze these attributes in the context of the historical data it has been trained on, allowing it to identify potential similarities or risk factors associated with previously recalled products.

At block 706, a risk score associated with the new product may be provided to the LLM. This risk score, which may be generated by the ML model as described in method 500, may indicate the possibility of the product being recalled. The LLM may use this score to gauge the severity of the potential risk and tailor its recommendations accordingly.

At block 708, one or more recommendations to mitigate the risk of recall of the new product may be obtained from the LLM. These recommendations may be based on the LLM's analysis of the historical data, the new product's attributes, and the associated risk score. The recommendations may include, but are not limited to, specific actions, design modifications, additional testing procedures, or other strategies that have proven effective in mitigating similar risks in the past.

The method 700 may provide a comprehensive approach to not only predicting the risk of product recalls but also generating actionable recommendations to mitigate these risks. By leveraging both ML and LLM, the method may offer a more nuanced and context-aware solution to product recall risk management. This approach may allow manufacturers to benefit from historical recall data and past mitigation strategies while tailoring recommendations to the specific attributes and risk profile of new products. Such a system may potentially enhance product safety, reduce recall incidents, and improve overall quality control processes across various industries.

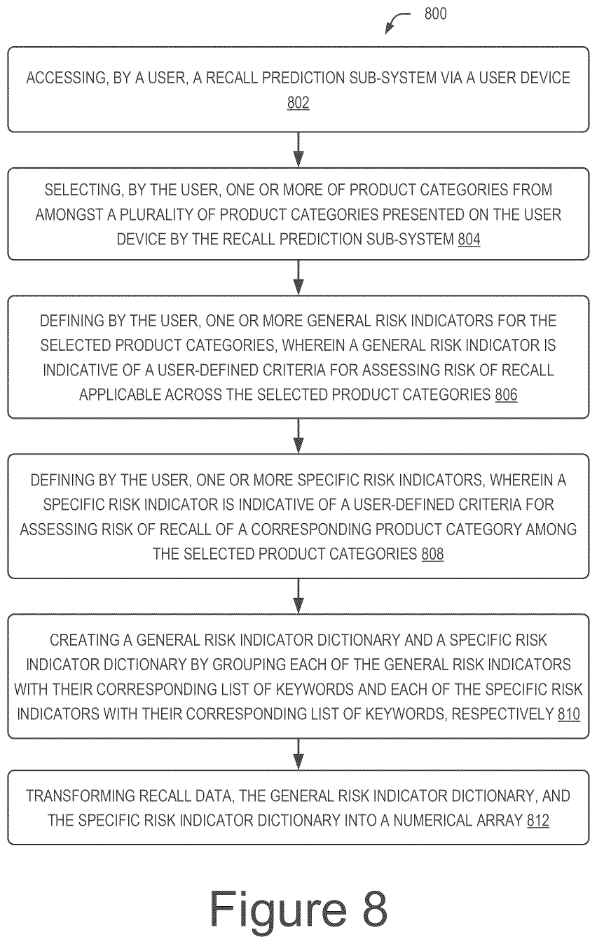

FIG. 8 illustrates a flow diagram of a process 800 for creating training data for a ML model, such as the ML model 340, for implementing example techniques for predicting the risk of recall of a product, in accordance with an example implementation of the present subject matter. The order in which the above-mentioned process is described is not intended to be construed as a limitation, and some of the described process blocks may be combined in a different order to implement the process, or an alternative process.

Furthermore, the above-mentioned process 800 may be implemented in suitable hardware, computer-readable instructions, or a combination thereof. The steps of such a process may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods. In an example, the process 800 may be implemented by the system 102, 300 of FIGS. 1-4.

The process 800 may be implemented in conjunction with methods 500 and 600, providing a more detailed explanation of the process for creating training data used in predicting the risk of product recalls. This method may elaborate on the initial steps of data collection and risk indicator definition described in methods 500 and 600.

At block 802, a user may access the recall prediction sub-system 330 via a user-device, such as the user device 114-1. As explained previously, the user device 114-1 may include, but are not limited to, mobile phones, tablets, computers, or other suitable electronic devices capable of interfacing with the recall prediction sub-system 104.

At block 804, the user may select one or more product categories from amongst a plurality of product categories presented on the user-device 114-1 by the recall prediction sub-system 330.

At block 806, the user may define one or more general risk indicators for the selected product categories. A general risk indicator may be indicative of a user-defined criteria for assessing risk of recall applicable across the selected product categories. These general risk indicators may correspond to the general risk indicators mentioned in methods 500 and 600.

At block 808, the user may define one or more specific risk indicators. A specific risk indicator may be indicative of a user-defined criteria for assessing risk of recall of the corresponding product category among the selected product categories. These specific risk indicators may align with the specific risk indicators discussed in methods 500 and 600.

At block 810, two distinct dictionaries: a general risk indicator dictionary and a specific risk indicator dictionary, nay be created, for example, by the generative module 336. As explained previously, the general risk indicator dictionary may be structured as a collection of entries, each entry comprising a general risk indicator paired with its corresponding list of keywords. Similarly, the specific risk indicator dictionary may be organized with each entry consisting of a specific risk indicator and its associated list of keywords.

At block 812, the recall data accessed from the one or more product recall databases 108-1, 108-2, . . . , and 108-N as indicated in step 502 of the method 500, the general risk indicator dictionary, and the specific risk indicator dictionary may be transformed, for example, by the training module 338, into a numerical array to be provided to the ML model 340 as a training data. As explained previously, the transformation process may involve techniques such as word embedding or vectorization, where textual data included in the recall data, the general risk indicator dictionary, and the specific risk indicator dictionary may be converted into dense numerical representations. For example, each keyword in the dictionaries and each reason for recall in the recall data may be mapped to a high-dimensional vector space using methods like Word2Vec, GloVe, or BERT. These numerical representations capture semantic relationships between words and phrases, allowing the ML model 340 to process and analyze the data more effectively. The resulting arrays may include features such as word frequency, TF-IDF scores, or contextual embeddings, providing a rich numerical representation of the textual data. This transformation enabling the ML model 340 to learn patterns and relationships from the historical recall data and risk indicator dictionaries, enhancing the ability of the ML model 340 to predict potential risks for new products.

The ML model 340 created by training on the recall data and dictionaries serves as a tool for estimating potential risks associated with products for which no prior recall data exists, aiding in proactive risk management strategies. By leveraging patterns and relationships learned from historical data and user-defined risk indicators, the ML model 340 may extrapolate potential risks to new products, enabling the manufacturers and the regulators to anticipate and mitigate potential issues before they lead to recalls. This predictive capability allows for more effective quality control measures, targeted safety assessments, and informed decision-making throughout the product lifecycle.

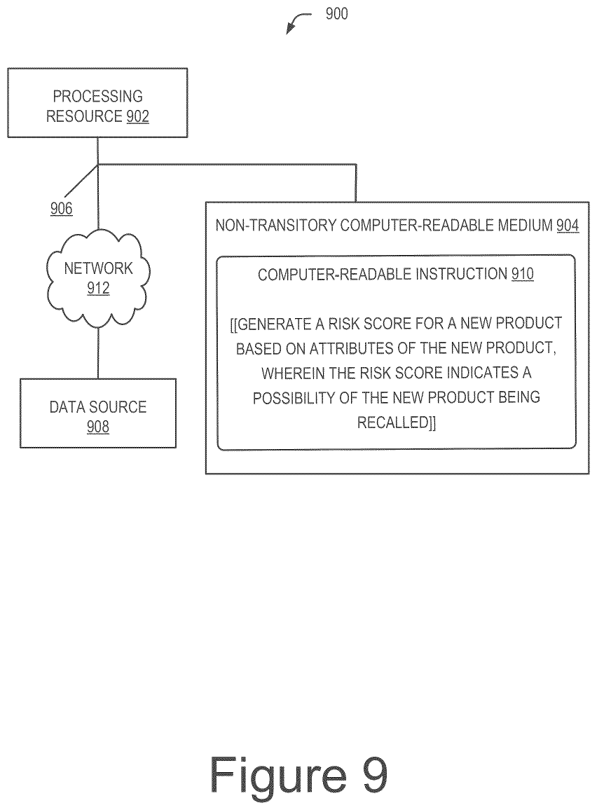

FIG. 9 illustrates a computing environment 900 for predicting risk of recall of product, according to an example implementation of the present subject matter. The computing environment 900 includes a processing resource 902 communicatively coupled to a non-transitory computer-readable medium 904 through a communication link 906. In an example, the processing resource 902 may be the processor of the product recall management system 102, 300, which fetches and executes computer-readable instructions from the non-transitory computer-readable medium 904.

The non-transitory computer-readable medium 904 may be, for example, an internal memory device or an external memory device. In an example implementation, the communication link 906 may be a direct communication link, such as any memory read/write interface. In another example implementation, the communication link 906 may be an indirect communication link, such as a network interface. In such a case, the processing resource 902 may access the non-transitory computer-readable medium 904 through a network 912. The network 912 may be a single network or a combination of multiple networks and may use a variety of different communication protocols.

The processing resource 902 and the non-transitory computer-readable medium 904 may also be communicatively coupled to data sources 908. The data source(s) 908 may be used to store data corresponding to the product recall management process, for example.

In an example implementation, the non-transitory computer-readable medium 904 comprises executable instructions 910 for enabling the predictions of risks of product recalls.

According to an example implementation of the present subject matter, the instructions 910 may cause the processing resource 902 to receive to access one or more product recall databases to obtain recall data pertaining to a plurality of categories of products. The recall data may comprise one or more reasons for recall relating to each of the plurality of product categories. The reasons for recall may be due to any number of factors, including but not limited to safety concerns, quality issues, regulatory non-compliance, design flaws, manufacturing defects, labeling errors, or newly discovered adverse effects. In an example, the instructions 910 may cause the processing resource 902 to carry out the functionality of the recall prediction sub-system 312 of the product recall management system 300 as explained above. For example, the instructions 910 may also cause the processing resource 902 to periodically retrieve updates to the recall data from the at least one product recall database.

The instructions 910 may cause the processing resource 902 to generate lists of semantically similar keywords for general risk indicators and specific risk indicators associated with the plurality of product categories. The general risk indicators and specific risk indicators may be previously defined based on user inputs. As explained previously, a general risk indicator is indicative of a user-defined criteria for assessing risk of recall applicable across the plurality of product categories, while a specific risk indicator corresponds to each product category from amongst the plurality of product categories Also as explained previously, the general risk indicators may include factors such as safety concerns, regulatory compliance issues, or supply chain vulnerabilities that may be applicable to various product categories. The specific risk indicators may include factors unique to a particular product type, such as material degradation for certain consumer goods, or biocompatibility for medical devices.

The instructions 910 may cause the processing resource 902 to generate lists of semantically similar keywords for each of the general risk indicators and specific risk indicators. As explained previously, in an example, the list of keywords may include terms like “defect,” “hazard,” “malfunction,” “contamination,” “failure,” “adverse reaction,” “non-compliance”, “manufacturing error,” and “quality issue” for general risk indicators, which may be applicable across various product categories. In the case of the specific risk indicators for a given category of product, such as an MRI machine, the factors may include: “magnetic field strength fluctuations”, “image quality degradation”, “helium leakage”, “RF interference”, “patient safety concerns”, and the like. In another example, the keywords may be generated using an LLM. Accordingly, in example implementations, the instructions 910 may cause the processing resource 902 to invoke the LLM. By generating semantically similar keywords for both general and specific risk indicators, the ability to identify potential risks across a wide range of product categories and specific product types may be improved.

The instructions 910 may cause the processing resource 902 to create a general risk indicator dictionary and a specific risk indicator dictionary by grouping each of the general risk indicators with their corresponding list of keywords and each of the specific risk indicators with their corresponding list of keywords, respectively. For example, in the case of a pharmaceutical product, the general risk indicator dictionary may include keywords such as “adverse reactions” with associated keywords like “side effects,” “allergic response,” and “drug interactions.” The specific risk indicator dictionary for this product category may include keywords such as “dosage accuracy” with keywords like “overdose,” “underdose,” and “inconsistent concentration.”

The instructions 910 may also cause the processing resource 902 to provide the general risk indicator dictionary and the specific risk indicator dictionary along with the recall data as a training data to train a machine learning (ML) model to predict risk of recall of product. The ML model then determines, based on the based on the general risk indicator dictionary and specific risk indicator dictionary, a degree of similarity between each of the general risk indicators and the specific risk indicators and the one or more reasons for recall of each of the plurality of product categories.

Once the ML model is trained, the instructions 910 may cause the processing resource 902 to obtain, from the ML model, a risk score for the new product in response to providing attributes of a new product to the ML model. The risk score indicates a possibility of the new product being recalled. In an example, the attributes may comprise specifications, features, materials, manufacturing processes, intended use, and any other relevant characteristics of the new product. In an example, these attributes may be provided by the manufacturer or obtained from the new product's documentation. The attributes may be used to assess the potential risks associated with the new product based on similarities to previously recalled products or known risk factors. In an example, the resulting risk score may be expressed as a numerical value or percentage, providing a quantitative assessment of the likelihood of a recall.

In an example, the instructions 910 may also cause the processing resource 902 to generate, based on the risk score, one or more recommendations to prevent and mitigate the predicted risk of recall of the product. In an example, the one or more recommendations are generated using a Large Language Model (LLM) trained on historic data comprising records of actions taken regarding previously recalled products.

Thus, the methods and systems of the present subject matter address the need for efficient product recall management. By enabling the recall prediction sub-system to predict and mitigate potential recall risks for new products before they are launched into the market, the system allows manufacturers to proactively identify and address potential issues, potentially reducing the likelihood and impact of future recalls. By leveraging historical recall data, user-defined risk indicators, and machine learning techniques, the system may provide a more comprehensive and objective approach to risk assessment compared to traditional manual methods. This automated approach may save time and resources while potentially improving product safety across various industries. Additionally, the system's ability to continuously update and refine its predictions based on new data may allow for ongoing improvement in risk assessment accuracy over time.

Overall, these advantages may contribute to improved product quality, reduced recall costs, and enhanced consumer safety. While specific implementations of the product recall management system have been discussed, it is to be understood that the appended claims are not necessarily limited to the specific features or methods described. Rather, the specific features and methods are disclosed as example implementations for enhancing the prediction of risk of recall of products across various industries.

While specific implementations of techniques for predicting a risk of recall of a product have been discussed, it is to be understood that the appended claims are not necessarily limited to the specific features or methods described. Rather, the specific features and methods are disclosed as example implementations for enhancing the efficiency and effectiveness of risk assessment processes across various product categories and industries, ultimately improving product safety and reducing the likelihood of recalls.

1. A system for predicting risk of recall of a product, comprising:
one or more processors;
a data retrieval module coupled to the one or more processors, wherein the data retrieval module is to access at least one product recall database to obtain recall data pertaining to a plurality of categories of products, the recall data comprising one or more reasons for recall relating to each of the plurality of product categories;
an input module coupled to one or more processors, wherein the input module is to receive from a user:
general risk indicators corresponding to the plurality of product categories, wherein a general risk indicator is indicative of a user-defined criteria for assessing risk of recall of the plurality of product categories; and
specific risk indicators corresponding to each product category from amongst the plurality of product categories, wherein a specific risk indicator is indicative of a user-defined criteria for assessing risk of recall of the corresponding product category;
a generative module coupled to one or more processors to:
generate a list of keywords for each of the general risk indicators and specific risk indicators, a keyword comprising one or more terms semantically similar to the corresponding risk indicator;
create a general risk indicator dictionary comprising a grouping of each of the general risk indicators with their corresponding list of keywords; and
create a specific risk indicator dictionary comprising a grouping of each of the specific risk indicators with their corresponding list of keywords; and
a training module coupled to the one or more processors, to provide the recall data, general risk indicator dictionary and specific risk indicator dictionary to a machine learning (ML) model, to train the ML model for predicting risk of recall of a product.

2. The system of claim 1, wherein, to train the ML model, the training module is to:
assign, based on the general risk indicator dictionary and specific risk indicator dictionary, a risk score for each of the general risk indicators and the specific risk indicators, the risk score being based on a degree of similarity between the corresponding risk indicator and the one or more reasons for recall of each of the plurality of product categories;
wherein the training module is further configured to, on providing a description of the product to the ML model, receive a risk score from the ML model, wherein the risk score is indicative of a possibility of the product to get recalled.

3. The system of claim 1, wherein the training module incorporates the ML model, the ML model being configured to, upon receiving a description of a product, generate a set of risk scores for the product, wherein each risk score corresponds to a general risk indicator or a specific risk indicator.

4. The system of claim 3, wherein the ML model is further configured to identify the general risk indicator or specific risk indicator associated with a highest risk score amongst the set of risk scores as a primary cause for recall of the product.

5. The system of claim 1, wherein the data retrieval module is further configured to periodically obtain updates to the recall data from the at least one product recall database.

6. The system of claim 1, wherein the generative module uses a Large Language Model (LLM) to generate the list of keywords for each of the general risk indicators and specific risk indicators.

7. The system of claim 1, further comprising a recommendation module coupled to the one or more processors, the recommendation module being configured to generate, based on the risk score, one or more recommendations to prevent and mitigate the predicted risk of recall of the product.

8. The system of claim 7, wherein the one or more recommendations are generated using a Large Language Model (LLM) trained on historic data comprising records of actions taken regarding previously recalled products.

9. A method for predicting risk of recall of a product, comprising:
accessing one or more product recall databases to obtain recall data pertaining to a plurality of categories of products, the recall data comprising one or more reasons for recall relating to each of the plurality of product categories;
obtaining a general risk indicator dictionary comprising a set of general risk indicators corresponding to the plurality of product categories, wherein a general risk indicator is indicative of a user-defined criteria for assessing risk of recall of the plurality of product categories;
obtaining a specific risk indicator dictionary comprising a set of specific risk indicators corresponding to each product category from amongst the plurality of product categories, wherein a specific risk indicator is indicative of a user-defined criteria for assessing risk of recall of the corresponding product category,
wherein the general risk indicator dictionary and specific risk indicator dictionary include a list of keywords for each of the general risk indicators and specific risk indicators, respectively, a keyword being a term semantically similar to the corresponding risk indicator;
training a Machine-Learning (ML) model, based on the recall data, for predicting risk of recall of a product, wherein the training comprises:
assigning, based on the general risk indicator dictionary and specific risk indicator dictionary, a risk score for each of the general risk indicators and the specific risk indicators, the risk score being based on a degree of similarity between the corresponding risk indicator and the one or more reasons for recall of each of the plurality of product categories; and
on providing a description of the product to the ML model, receiving a risk score from the ML model, wherein the risk score is indicative of a possibility of the product being recalled.

10. The method of claim 9, further comprising:
generating, by the ML model, a set of risk scores for the product, wherein each risk score is associated with a general risk indicator or a specific risk indicator.

11. The method of claim 10, further comprising identifying, by the ML model, the general risk indicator or specific risk indicator associated with a highest risk score amongst the set of risk scores as a primary cause for recall of the product.

12. The method of claim 9, further comprising, using a Large Language Model (LLM) to generate the list of keywords for each of the general risk indicators and specific risk indicators.

13. The method of claim 9, further comprising, generating, based on the risk score, one or more recommendations to prevent and mitigate the predicted risk of recall of the product.

14. The method of claim 13, wherein the one or more recommendations are generated using a Large Language Model (LLM), wherein the LLM is trained on historic data comprising records of actions taken regarding previously recalled products.

15. A non-transitory computer-readable medium comprising instructions that, when executed by one or more processors, cause the one or more processors to:
access recall data pertaining to a plurality of categories of products from at least one product recall database, the recall data comprising one or more reasons for recall of each of the plurality of product categories;
receive user input defining general risk indicators corresponding to the plurality of product categories, wherein a general risk indicator is indicative of a user-defined criteria for assessing risk of recall applicable across the plurality of product categories, and specific risk indicators corresponding to each product category from amongst the plurality of product categories, wherein a specific risk indicator is indicative of a user-defined criteria for assessing risk of recall of the corresponding product category;
generate lists of semantically similar keywords for each of the general risk indicators and specific risk indicators;
create a general risk indicator dictionary and a specific risk indicator dictionary by grouping each of the general risk indicators with their corresponding list of keywords and each of the specific risk indicators with their corresponding list of keywords, respectively;
provide, to a machine learning (ML) model, the general risk indicator dictionary and the specific risk indicator dictionary along with the recall data as training data to train the ML model to predict risk of recall of a product, wherein the ML model is to determine, based on the general risk indicator dictionary and specific risk indicator dictionary, a degree of similarity between each of the general risk indicators and the specific risk indicators and the one or more reasons for recall of each of the plurality of product categories;
obtain, from the ML model, in response to providing attributes of a new product to the ML model, a risk score for the new product, the risk score indicating a possibility of the new product being recalled.

16. The non-transitory computer-readable medium of claim 15, further comprising instructions executable by the processing resource to cause the one or more processors to:
generate, using the ML model, a set of risk scores for the product, wherein each risk score is associated with a general risk indicator or a specific risk indicator.

17. The non-transitory computer-readable medium of claim 16, further comprising instructions executable by the processing resource to cause the one or more processors to:
identify, the general risk indicator or specific risk indicator with a highest risk score amongst the set of risk scores as a primary cause for recall of the product.

18. The non-transitory computer-readable medium as claimed in claim 14, further comprising instructions executable by the processing resource to generate, based on the risk score, one or more recommendations to prevent and mitigate the predicted risk of recall of the product.

19. The non-transitory computer-readable medium of claim 14, wherein the one or more recommendations are generated using a Large Language Model (LLM) trained on historic data comprising records of actions taken regarding previously recalled products.

20. The non-transitory computer-readable medium of claim 14, further comprising instructions executable by the processing resource to cause the one or more processors to periodically retrieve updates to the recall data from the at least one product recall database.
